(19) United States
(12) Patent Application Publication
(10) Pub. No.: US 2014/0351015 A1
(43) Pub. Date: Nov. 27, 2014

(54) METHODS, SYSTEMS, DEVICES AND ARRANGEMENTS FOR PROVIDING GIFTS

(71) Applicant: BOHEMIAN WRAPPSODY AB, Stockholm (SE)

(72) Inventors: Andreas EHN, San Francisco, CA (US); Leo GIERTZ, Stockholm (SE); Magnus HULT, Stockholm (SE); Hjalmar WINBLADH, Saltsjo-Boo (SE)

(21) Appl. No.: 14/455,397

(22) Filed: Aug. 8, 2014

Related U.S. Application Data
(63) Continuation of application No. PCT/EP2013/053657, filed on Feb. 25, 2013.
(60) Provisional application No. 61/640,376, filed on Apr. 30, 2012.
(60) Provisional application No. 61/604,078, filed on Feb. 28, 2012.

(51) Int. Cl. G06Q 30/06; G06Q 50/00; G06Q 30/02

(52) U.S. Cl. CPC G06Q 30/0631; G06Q 30/0202; G06Q 30/0643; G06Q 50/01
USPC 705/7.31; 705/26.7

(57) ABSTRACT

A social gift-giving system is operable with a social networking service such as Facebook. A graphical user interface (GUI) is provided on a display of a computing device. A user logs in to the social networking service. Responsive to selection of a first region of the GUI, the GUI displays a list of other users of the social networking service associated with the first user. These other users may be the first user's Facebook friends. Using the GUI, the user can select a Facebook friend, select a gift for the friend, and purchase the gift for the friend.

### RELATED APPLICATIONS

This application is a continuation of PCT/EP2013/053657, filed Feb. 25, 2013, titled “METHODS, SYSTEMS, DEVICES AND ARRANGEMENTS FOR PROVIDING GIFTS,” the entire contents of which are hereby fully incorporated herein by reference for all purposes. PCT/EP2013/053657 claimed the benefit of U.S. provisional applications nos. (i) 61/604,078, filed Feb. 28, 2012 and (ii) 61/640,376, filed Apr. 30, 2012, the entire contents of each of which are hereby fully incorporated herein by reference for all purposes.

### COPYRIGHT STATEMENT

This patent document contains material subject to copyright protection. The copyright owner has no objection to the reproduction of this patent document or any related materials in the files of the United States Patent and Trademark Office, but otherwise reserves all copyrights whatsoever.

### FIELD OF THE INVENTION

This invention relates to gift giving. More particularly, in some aspects, this invention relates to methods, systems, devices, and arrangements for providing gifts via online services such as social networking services.

### BRIEF DESCRIPTION OF THE DRAWINGS

Other objects, features, and characteristics of the present invention as well as the methods of operation and functions of the related elements of structure, and the combination of parts and economies of manufacture, will become more apparent upon consideration of the following description and the appended claims with reference to the accompanying drawings, all of which form a part of this specification.

FIGS. 1-2 are logical depictions of components of a gifting system;

FIGS. 3-4 provide overviews of functional connectivity of components shown in FIGS. 1-2;

FIG. 5(a) is a schematic diagram of a computer system;

FIGS. 5(b)-5(c) are logical depictions of applications used in the gifting system;

FIGS. 5(d)-5(e) are logical depictions of processes used in the gifting system;

FIGS. 5(f)-5(g) are examples of aspects of typical devices used to access the gifting system;

FIGS. 6(a)-6(h) depict logical aspects of a graphical user interface (GUI) for a gifting system of FIGS. 1-2;

FIGS. 7(a)-7(f) are flowcharts describing aspects of embodiments of the gifting system;

FIGS. 8(a)-8(r), 9(a)-9(j) and 10(a)-10(k) depict aspects of exemplary graphical user interfaces (GUI) of embodiments of a gifting system.

### DETAILED DESCRIPTION OF THE PRESENTLY PREFERRED EXEMPLARY EMBODIMENTS

### Background and Overview

Methods, systems and devices are described herein supporting gifting applications, platforms, systems, frameworks and services, preferably via a social networking services (SNS) such as Facebook.

In some aspects of exemplary embodiments, the platform(s) may function as a digital community for people to celebrate and be celebrated by friends and family by sending and receiving gifts (e.g., gift cards). The platform(s) may direct unique offers to users related, e.g., to their profile and interests. The platform(s) and services may be made available via one or more of: website(s), using mobile applications (e.g., available for iPhone and Android), and/or via social networks (e.g., Facebook), and/or via third-party application stores.

### Description

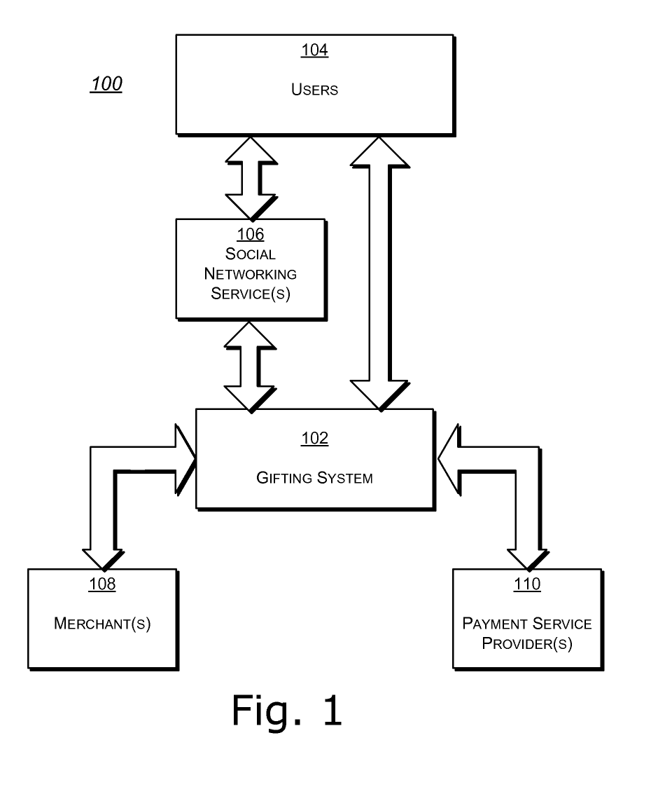

FIG. 1 is a logical depiction of components of a gifting framework 100, including a gifting system 102. The gifting system 102 is operationally connected or connectable to users 104, either directly or via one or more social networking services 106. The gifting system 102 is also operationally connected or connectable to one or more merchants 108 and to one or more payment service providers 110.

As used here, the term “user” may refer to a person or to a person's access device such as a computer system (e.g., desktop or laptop), a tablet device (e.g., an Apple iPad or the like), a mobile phone or smartphone (e.g., an Apple iPhone, an Android™ based device, a BlackBerry®, or the like), or a set-top box. Those of skill in the art will realize and understand, upon reading this description, that the system is not limited in any way by the type of device(s) or system(s) that users may use to access the system.

The social networking services 106 may include Facebook, MySpace, LinkedIn or any other social network service. Those of skill in the art will realize and understand, upon reading this description, that the system is not limited in any way by which any social network service/services is/are used.

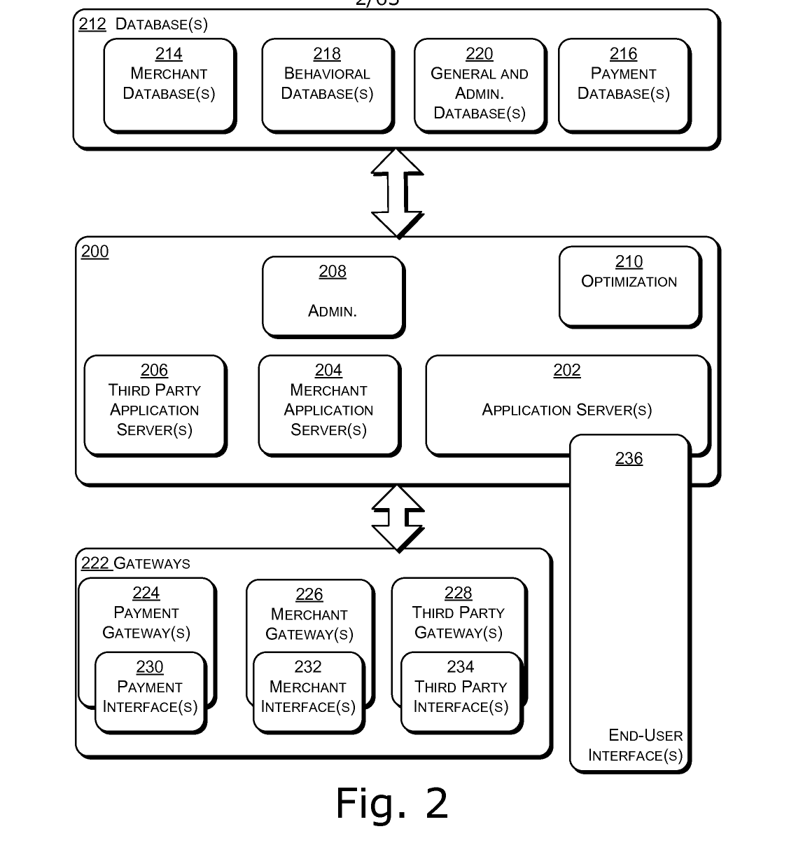

FIG. 2 is a logical depiction of components of the gifting system 102 of the gifting framework 100 of FIG. 1(a). As shown in FIG. 2, the gifting system 102 may include various applications and/or servers 200, including one or more application servers 202, one or more merchant application servers 204, and one or more third party application servers 206. The applications and/or servers 200 may include administrative applications 208 and an optimization engine/application 210. The administrative applications 208 and an optimization engine/application 210 run on one or more computers (not shown).

Those of skill in the art will realize and understand, upon reading this description, that the term server may refer to software and/or hardware and, even when used in the plural, may refer to a single hardware device. The term server, when used in the singular, may refer to software and/or hardware operating on multiple hardware devices. In presently preferred implementations there are multiple hardware application servers 202.

The gifting system 102 also includes storage including one or more databases 212, operationally connected and/or connectable to various of the applications and/or servers 200. The databases include one or more merchant databases 214, one or more payment databases 216, one or more behavioral databases 218, and one or more general and administrative databases 220.

Access to the various databases may be controlled using known security and access control techniques and mechanisms. As will be appreciated, not all data in the databases are accessible to all applications or users.

The merchant database(s) 214 store and maintain merchant data relating to offers from current merchants 108. In some system merchants are required to subscribe to the system, and the merchant database(s) 214 may include data related to merchant subscriptions. The payment database(s) 216 store and maintain data relating to payments, e.g., those made by users 104 using payment service provider(s) 110 via the payment gateway(s) 224. The administrative database(s) 220 store and maintain data related to operation of the system. The behavioral database(s) 218 store and maintain data about user behavior as well as historical data. As will be explained in greater detail below, information in the behavioral database(s) 218 may be used to provide information to one or more other components of the system, including to the optimization engine 210.

The system is not limited by the form in which data are stored in the various databases.

The gifting system 102 provides various gateways and interfaces to the applications and/or servers 200. The gateways 222 include one or more payment gateways 224, and one or more merchant gateways 226. The gifting system 102 may also provide one or more third party gateways 228. Each gateway preferably provides and/or supports one or more interfaces. The payment gateway(s) 224 provide/support one or more payment interfaces 230 to payment service providers (110 in FIG. 1). The merchant gateway(s) 226 provide/support one or more merchant interfaces 232. The third party gateway(s) 228 provide/support one or more third party interfaces 234.

Those of skill in the art will realize and understand, upon reading this description, that the various merchant interfaces, third party interfaces, and payment interfaces may be web-based interfaces or the like.

The gifting system 102 also provides users 104 with one or more end-user interfaces 236. These interfaces may be web based or they may use device-specific applications. For example, a user interface may be provided for use on specific mobile devices (e.g., an iPhone or an Android or the like). It should be appreciated that the end-user interfaces 230 may provide access to the gifting system 102 directly or via one or more social networking services 106. In some cases an end-user interface 230 may use APIs (Application Program Interfaces) provided by a social networking service. In these cases, the end-user's interaction with the gifting system may be transparent to the end-user. In addition, there may be multiple interfaces to a gifting system. For example, different entities (e.g., different merchants) may provide branded entry/access to the system. The end-user interfaces 236 may be graphical user interfaces (GUIs), as described in greater detail below.

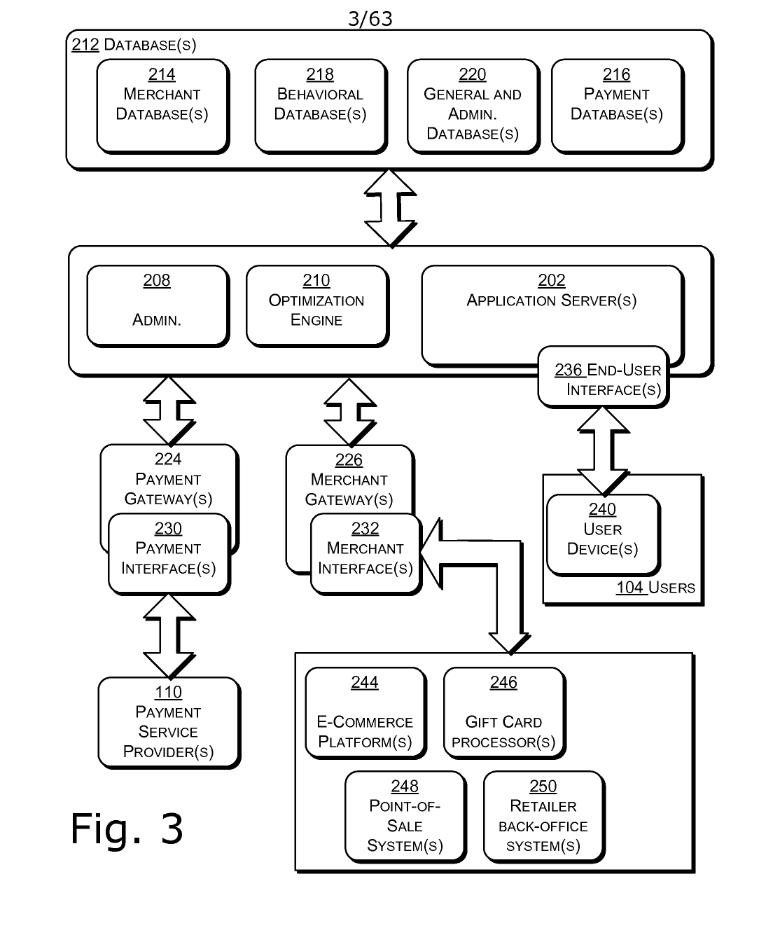

FIG. 3 is a logical depiction of components of the gifting system 102 of the gifting framework 100 of FIGS. 1 and 2. As shown in FIG. 3, users 104 access the application server(s) 202 via user devices 240. These devices may include computer systems (e.g., desktops or laptops), tablet devices (e.g., iPad and the like), smart phones (e.g., Apple iPhones, Androids, BlackBerry devices, smart phones and the like), and set-top boxes. The user devices 240 may be incorporated into other devices (e.g., into television sets and the like). Those of skill in the art will realize and understand, upon reading this description, that the system is not limited in any way by the type of device or system that users may use to access the system. It will be appreciated that user devices 240 will access the application servers using appropriate end-user interfaces 236. For example, a desktop computer device may access the application server(s) via a standard web browser running on the computer device. In preferred implementations, the gifting system provides one or more graphical user interfaces (GUIs) as end user interfaces to the application servers. These GUIs may be implemented using standard browsers or using customized applications running on the user devices.

Users of the gifting system (including end users 104) may access the gifting system (and the application servers) using any kind of networks, including wired or wireless networks, cellular networks, satellite networks, or any combinations thereof. In addition, users may be provided with access to the system via specialized devices such as kiosks and the like. It should be appreciated that the kinds of networks being used to access the system will depend, at least in part, on the devices being used. E.g., a mobile phone user may access the gifting system via one or more cellular networks and/or wireless networks, whereas a user of a desktop computer system may access the system via a LAN and a wired network. Those of skill in the art will realize and understand, upon reading this description, that the system is not limited in any manner by the type of network or medium used to access the system.

As shown in FIG. 3, the payment gateway(s) 224 provide access to one or more payment service providers 110 via the payment interface(s) 230. The payment service providers 110 may include banks, credit card companies, online payment companies such as PayPal, or the like. It should be appreciated that any form of payment system may be used and that any particular gifting framework 100 may support multiple payment service providers 242 using multiple forms of payment. It should also be appreciated that payment may use real or virtual currency, so that payment may include money alone or in combination with points from a loyalty program. For example, a particular merchant may offer a loyalty program that allows its users to use loyalty points as payment. These loyalty points may be used alone or in combination with cash to pay for gifts. In some cases a user may be able to give the loyalty points themselves as gifts.

It should be appreciated that not all gifts will require payment, and that many gifts or merchant campaigns may be in the form of coupons and the like that are given away for free or reduced value, e.g., in order to obtain (or reward) customers.

A merchant 108 may offer a direct and/or an indirect connection to the gifting system 102. With further reference to FIG. 3, the merchant gateway(s) 226 may provide the gifting system 102 with operational connection(s) to one or more other entities such as, e.g., e-commerce platform(s) 244, gift card processor(s) 246, point-of-sale system(s) 248, and retailer back-office system(s) 250. It should be appreciated that the system is not limited by the manner in which merchants interface with the gifting system or by the kinds of interfaces a merchant provides. Those of skill in the art will realize and understand, upon reading this description, that a particular merchant may provide more than one entity for the gifting system. For example, a restaurant may provide direct access via a point-of-sale system and an e-commerce platform, as well as indirect access via a gift card processor.

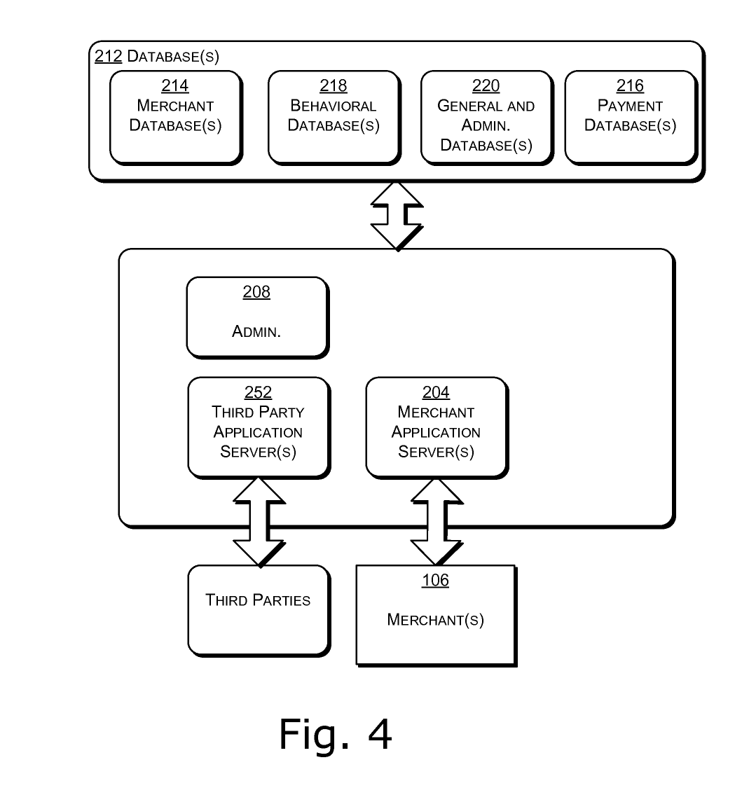

FIG. 4 shows additional aspects of the gifting system 102 of the gifting framework 100 of FIGS. 1 and 2. As shown in FIG. 4, merchant(s) 106 may access the merchant application server(s) 204, e.g., to perform administrative functions. Merchant access to the merchant application server(s) may be via specialized interfaces that support the required authentication, security checking, and the like. For example, in some cases a merchants may access the merchant application servers via a secure web site hosted on the application servers.

In some cases, as shown in FIG. 4, the gifting system 102 includes one or more third party application servers 254 which support third party applications.

Computing Overview

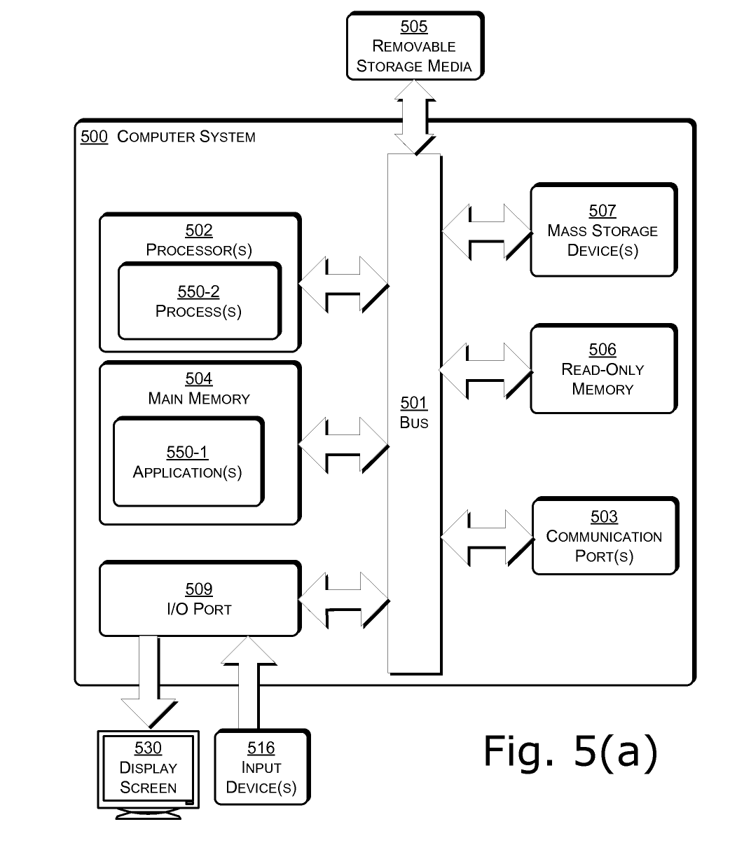

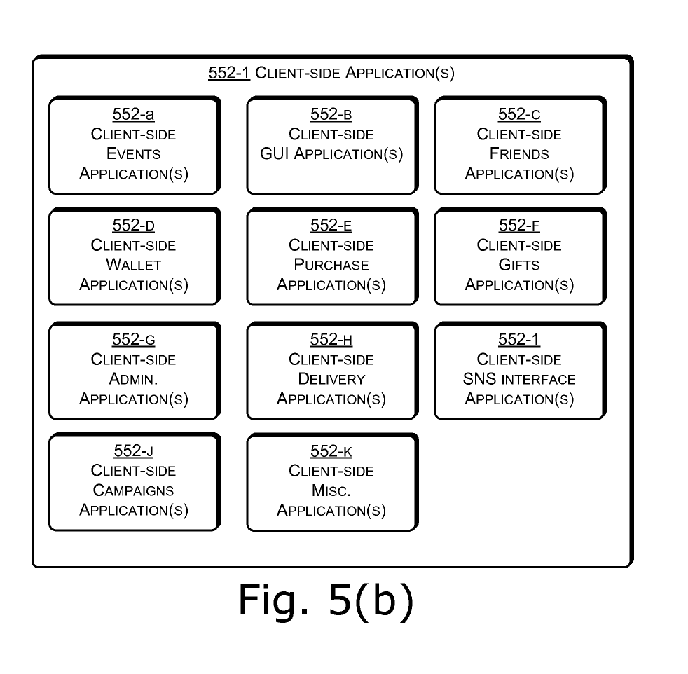

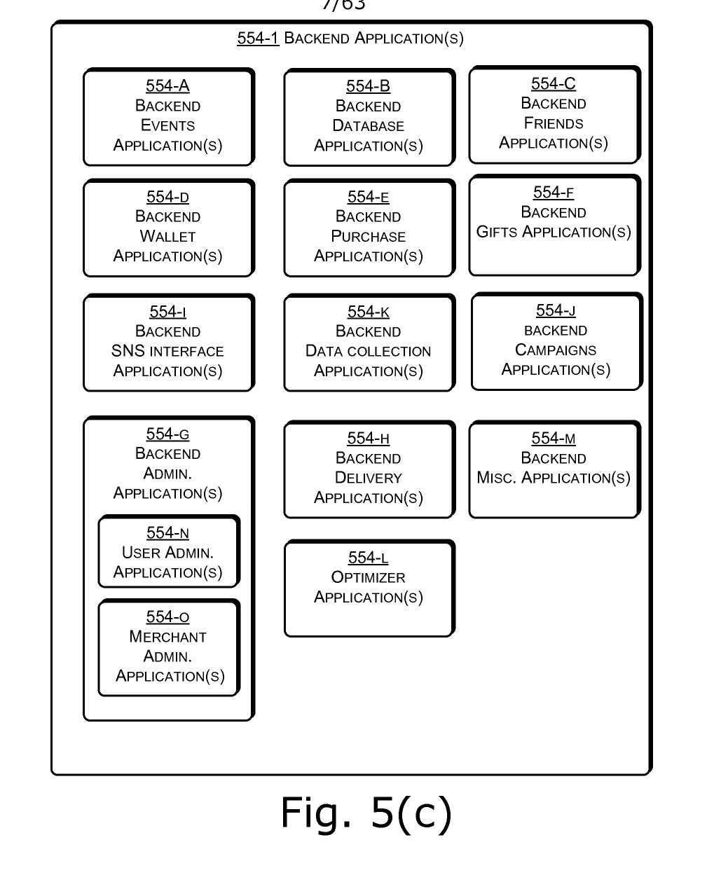

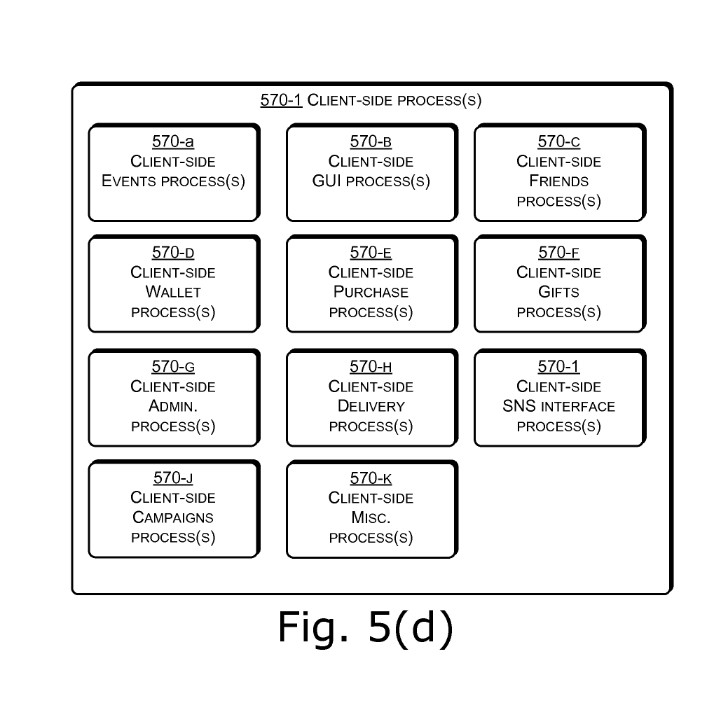

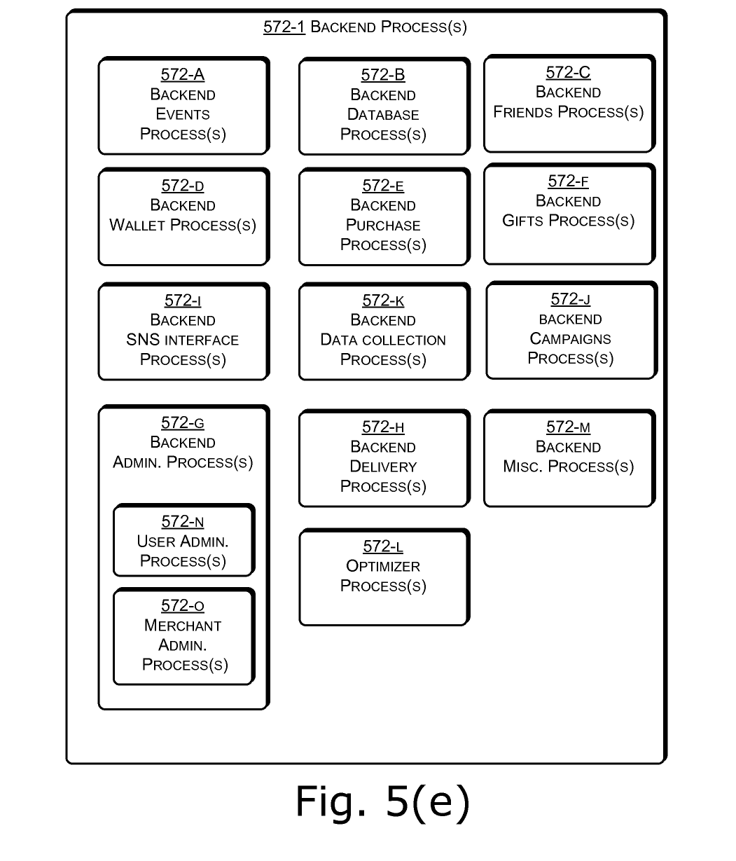

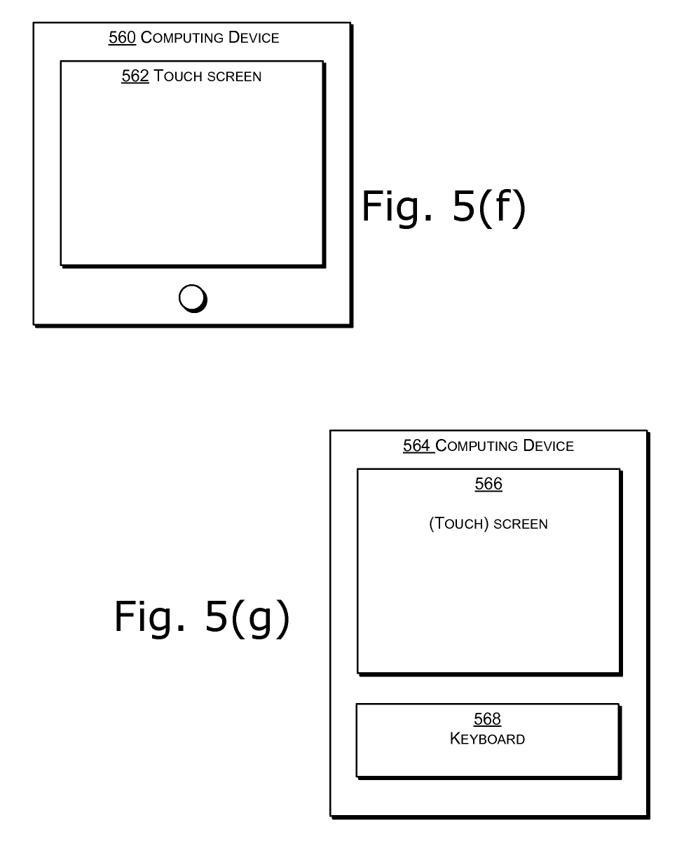

FIG. 5(a) is a schematic diagram of a computer device/system 500 upon which embodiments/aspects of the present disclosure may be implemented and carried out. According to the present example, the computer system 500 includes a bus 501 (i.e., interconnect), at least one processor 502, at least one communications port 503, a main memory 504, a removable storage media 505, a read-only memory 506, and a mass storage 507. The computer system 500 may be in communication with peripheral devices (e.g., one or more display device(s) 530, and one or more input device(s) 516) via Input/Output (I/O) port 509. The display devices 530 may be, e.g., display screens and the like, and the one or more input devices 516 may be, e.g., keyboards, touch screens, voice recognized input and the like. It should be appreciated that the input devices 516 may be integrated into the display devices 530, such as in the case of a device having a touch screen.

As shown, main memory 504 is encoded with one or more applications 550-1 that support the functionality as discussed herein. Application(s) 550-1 (and/or other resources as described herein) can be embodied as software code such as data and/or logic instructions (e.g., code stored in the memory or on another computer readable medium such as a disk) that supports processing functionality according to different embodiments described herein.

During operation of at least one embodiment, processor(s) 502 accesses main memory 504 via the use of bus 501 in order to launch, run, execute, interpret or otherwise perform the logic instructions of the application(s) 550-1. Execution of an application 550-1 produces processing functionality in process 550-2. In other words, the process 550-2 represents one or more portions of the application 550-1 performing within or upon the processor(s) 502 in the computer system 500.

With reference to FIGS. 5(b)-5(c), in some embodiments the application(s) 550-1 may include client-side applications 552-1 and backend or server-side applications 554-1. For the purposes of this description, the operations carried out on a user's computing device are considered client-side operations, and the operations carried out on the gifting system computer system(s) are considered backend or server-side operations. It should be appreciated that this breakdown is only provided to explain certain aspects of the system, and this naming convention is not intended to limit the scope of the system in any way. Those of skill in the art will realize and understand, upon reading this description, that certain aspects of the system may be implemented on the client side or the backend or in a combination of both.

Some or all of the client side applications 554-1 will operate on a user's computing device in order to implement aspects of the gifting system. Some or all of the backend applications 554-1 will operate on the gifting system's computing device(s) in order to implement aspects of the gifting system.

As shown in FIG. 5(b), the client-side applications 552-1 may include one or more of: client-side events application(s) 552-a, client-side GUI application(s) 552-b, client-side friends application(s) 552-c, client-side wallet application(s) 552-d, client-side purchase application(s) 552-e, client-side gifts application(s) 552-f, client-side administrative application(s) 552-g, client-side delivery application(s) 552-h, client-side SNS interface application(s) 552-i, client-side campaign application(s) 552-j, and other client-side application(s) 552-k.

As shown in FIG. 5(c), the backend or server-side applications 554-1 may include one or more of: backend events application(s) 554-a, backend database application(s) 554-b, backend friends application(s) 554-c, backend wallet application(s) 554-d, backend purchase application(s) 554-e, backend gifts application(s) 554-f, backend administrative application(s) 554-g, backend delivery application(s) 554-h, backend SNS interface application(s) 554-i, backend campaigns application(s) 554-j, backend data collection application(s) 554-k, backend optimizer application(s) 554-l, and other backend application(s) 554-m. The backend administrative applications may include user administrative applications 554-n and merchant administrative applications 554-o.

Although shown as separate applications in the drawing, this separation is for descriptive purposes only, and it should be appreciated that the particular functionality associated with any particular application may be shared with or integrated into other applications. Those of skill in the art will realize and understand, upon reading this description, that the applications may be separate and distinct or that some or all of the applications may be incorporated into programs supporting their combined functionality.

There are preferably client-side processes corresponding to the various client-side applications. Thus, e.g., as shown in FIG. 5(d), the client-side processes 570-1 may include one or more of: client-side events process(s) 570-a, client-side GUI process(s) 570-b, client-side friends process(s) 570-c, client-side wallet process(s) 570-d, client-side purchase process(s) 570-e, client-side gifts process(s) 570-f, client-side administrative process(s) 570-g, client-side delivery process(s) 570-h, client-side SNS interface process(s) 570-i, client-side campaign process(s) 570-j, and other client-side process(s) 570-k.

There are preferably backend processes corresponding to the various backend applications. Thus, e.g., as shown in FIG. 5(e), the backend or server-side processes 572-1 may include one or more of: backend events process(s) 572-a, backend database process(s) 572-b, backend friends process(s) 572-c, backend wallet process(s) 572-d, backend purchase process(s) 572-e, backend gifts process(s) 572-f, backend administrative process(s) 572-g, backend delivery process(s) 572-h, backend SNS interface process(s) 572-i, backend campaigns process(s) 572-j, backend data collection process(s) 572-k, backend optimizer process(s) 572-l, and other backend process(s) 572-m. The backend administrative process(s) 572-g may include user administrative process(s) 572-n and merchant administrative process(s) 572-o.

FIGS. 5(f)-5(g) show aspects exemplary computing devices/systems that may be used to interface with and interact with the gifting system 100. FIG. 5(d) depicts a tablet device 560 (such as an Apple iPad or the like) having a touch screen 562. FIG. 5(e) depicts a smartphone device 564 (such as a Blackberry or the like) having an integrated keyboard 568 and a screen 566 (which may be a touch screen).

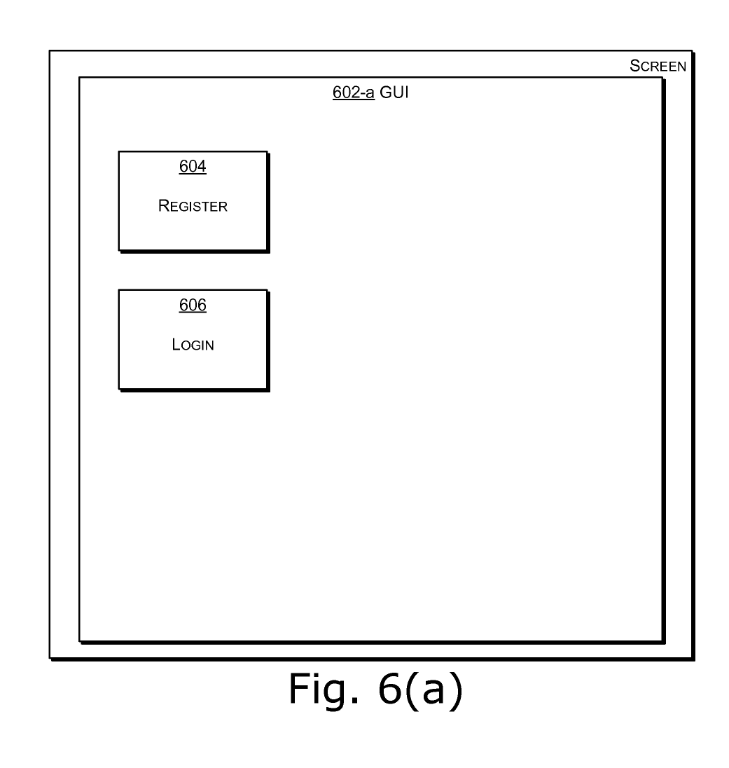

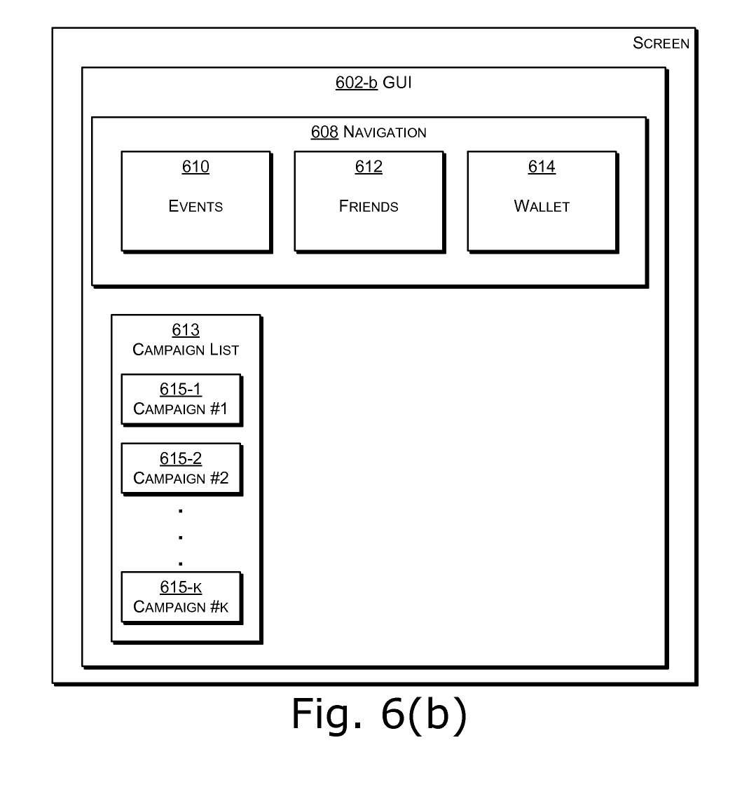

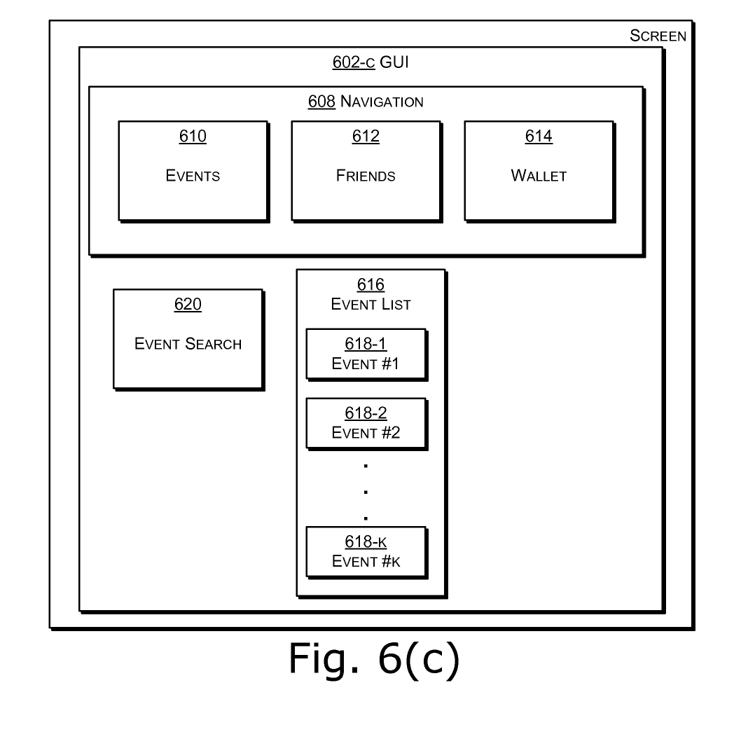

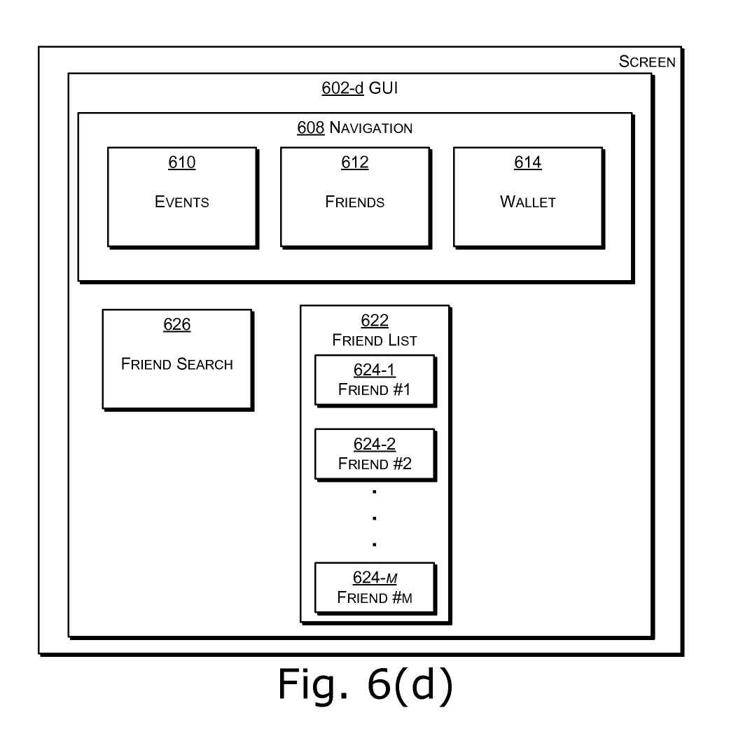

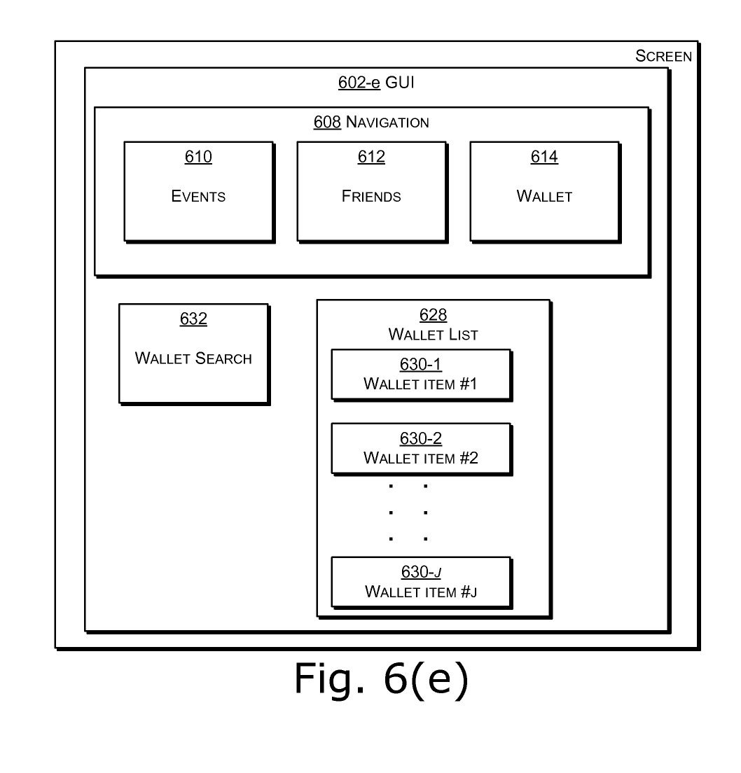

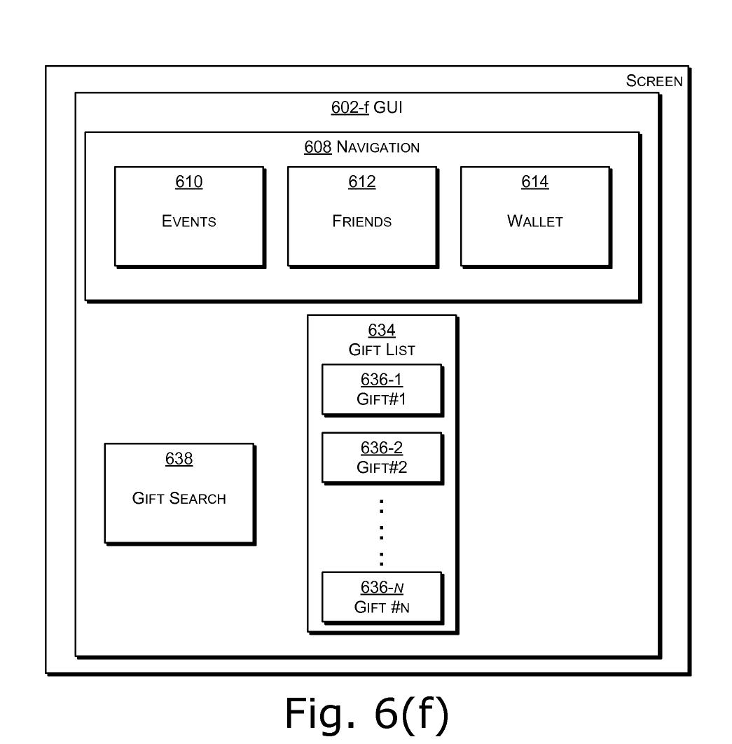

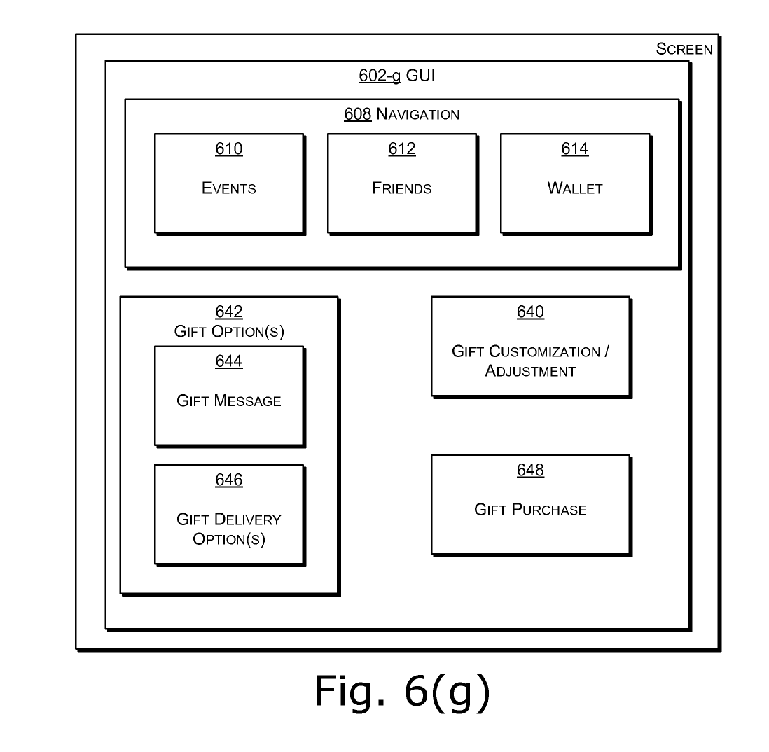

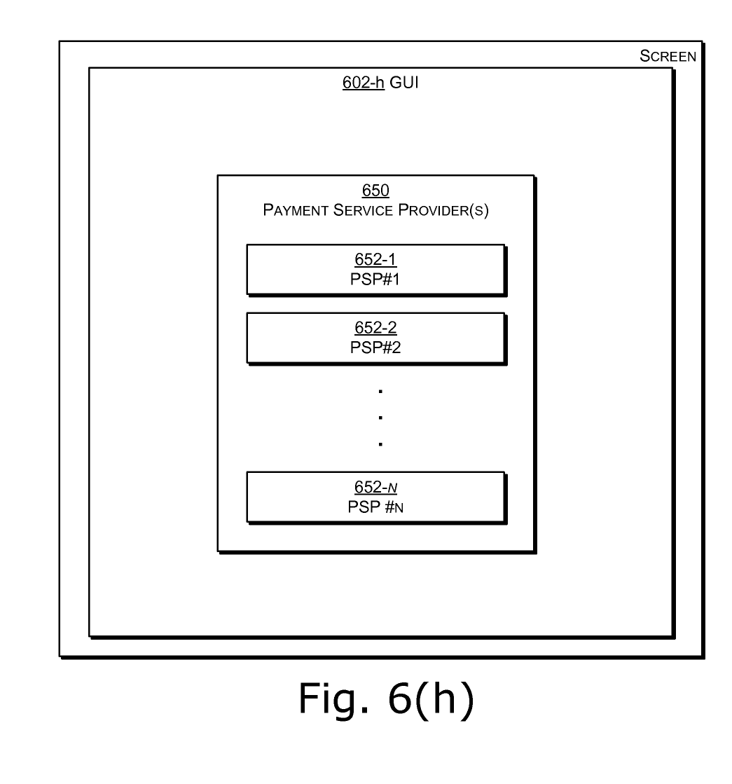

FIGS. 6(a)-6(h) depict logical aspects of a graphical user interface (GUI) 602 for a gifting system 102 of FIGS. 1-2. This GUI corresponds to an end-user interface 236 of FIG. 2. The GUI 602 (and with the other GUIs shown herein) may be implemented, at least in part, using client-side GUI application(s) 552-b on the user's computing device. The GUI 602 may be implemented, e.g., using HTML and/or Java™ through the browser of a user's computing device or the GUI may be implemented as an application running on the user's computing device. Those of skill in the art will realize and understand, upon reading this description, that the system is not limited by the manner in which the GUI is implemented. Aspects of the GUI may also be implemented, at least in part, using the client-side SNS interface application(s) on the user's computing device, alone or in interaction/combination with backend SNS application(s) 554-i on one or more computer systems associated with the gifting system 102.

As shown in FIG. 6(a), the GUI 602 preferably includes a registration portion or region 604 (denoted “REGISTER”) and a login portion or region 606 (denoted “LOGIN”). These regions each have functionality associated therewith. This functionality may be implemented, at least in part, using the client-side administrative application(s) 552-g on the user's computing device, alone or in combination with the backend user administrative application(s) 554-n on one or more computer systems associated with the gifting system 102.

Those of skill in the art will realize and understand, upon reading this description, that when functionality is implemented by a client-side application on a user's computing device, that functionality may be implemented by a corresponding client-side process executing on the user's computing device. Similarly, when functionality is implemented by a backend application on one or more computer systems associated with the gifting system, then that functionality is implemented by corresponding back-end process(es) executing on the one or more computer systems associated with the gifting system. It should be appreciated that, as used herein, the term “executing” refers to one or more of launching, running, executing, interpreting and/or otherwise performing the logic instructions of the application. The system is not limited in any way by the manner in which processes are executed.

Thus, e.g., the functionality associated with the registration portion or region 604 and a login portion or region 606 may be implemented, at least in part, using client-side processes 570 including the client-side administrative process(es) 570-g running on the user's computing device, alone or in combination with backend processes including the backend user administrative process(es) 572-n running on one or more computer systems associated with the gifting system 102

For example, a user selecting the registration portion or region 604 will invoke functionality in the application(s)/process(es) that allows the user to register with the system. Similarly, a user selecting the login region 606 will invoke functionality that allows the user to login to the system. The functionality associated with a particular region may involve any functionality that may be associated with a GUI, including one or more of: directing the user to another web page, running a function, etc. The functionality associated with any region in the GUI may be implemented using one or more of: HTML, Java, etc. Some or all of the functionality associated with a particular region may be implemented by other computer devices, e.g., remote devices that are contacted via a network or the like.

In FIG. 6(a) and the following drawings of the GUI 602, the various interface regions or portions are shown as rectangular shapes. It should be appreciated that a particular implementation of the GUI may use any shape(s) or other method(s) to allow a user to invoke a function. Thus, e.g., the login region 604 may be denoted by a rectangle marked “Login” and by a drawing or other image. In that case a user may select either region to invoke the login functionality.

While FIGS. 6(a)-6(h) depict logical aspects of a graphical user interface 602, it should be appreciated that not every system will have all of the interface items shown and further, that the interface items shown may appear in different forms and/or locations on any particular implementation of the GUI. It should further be appreciate that a particular implementation of a GUI may include additional interface regions and support other functionality.

For the purposes of this description, a user 104 who uses the system to give a gift to someone is sometimes referred to as a gift giver or giver. It should be appreciated that the terms “gift giver” and “giver” are used for explanatory purposes and not to limit the scope of the system in any way.

As used herein the term “gift” refers to anything given by one party to another and does not imply any relationship between the parties or any particular event for which the gift is given or any particular value that the gift may have to either of the parties. Gifts may be free or paid. Gifts may be sponsored by merchants and/or by other third parties. Gifts may have value assigned by merchants and/or by other third parties. A gift's value may, in some cases, be changed (increased) by a gift giver or a third party or another user. Gifts may be transferable or restricted to the user to whom they are initially given.

In order to use the gifting system 102, a user (gift giver) 104 must preferably be registered with the system using one or more of the supported social networking services (SNSs) 106. The gift giver may access the system using a GUI, e.g., a web interface, via a computer device/system or a smartphone or the like (e.g., as shown in FIGS. 5(a)-5(c)). The user may also use their smartphone's phonebook to connect to the SNS.

FIG. 6(a) depicts a GUI 602 through which a user may register with or login to the gifting system 102. The user may register by selecting the register region 604 of the GUI and by following the registration procedure associated with that region. If a user is already registered, that user may login to the gifting system 102 by selecting the login region 606 of the GUI and then following the login procedure associated with that region.

It should be appreciated that the manner in which a user selects a region depicted on a screen of a display device will depend on the kind of device and on the operating system that device is operating. For example, as is well known, a user may select a region using a mouse or other pointing device to point to the region and then click the mouse (with an appropriate number of clicks) to select the region and to follow the action set by the region. Users of touch screen devices may touch the screen in the area of a region in order to select the region. The system is not in any way limited by the manner in which users select regions or options on a display screen.

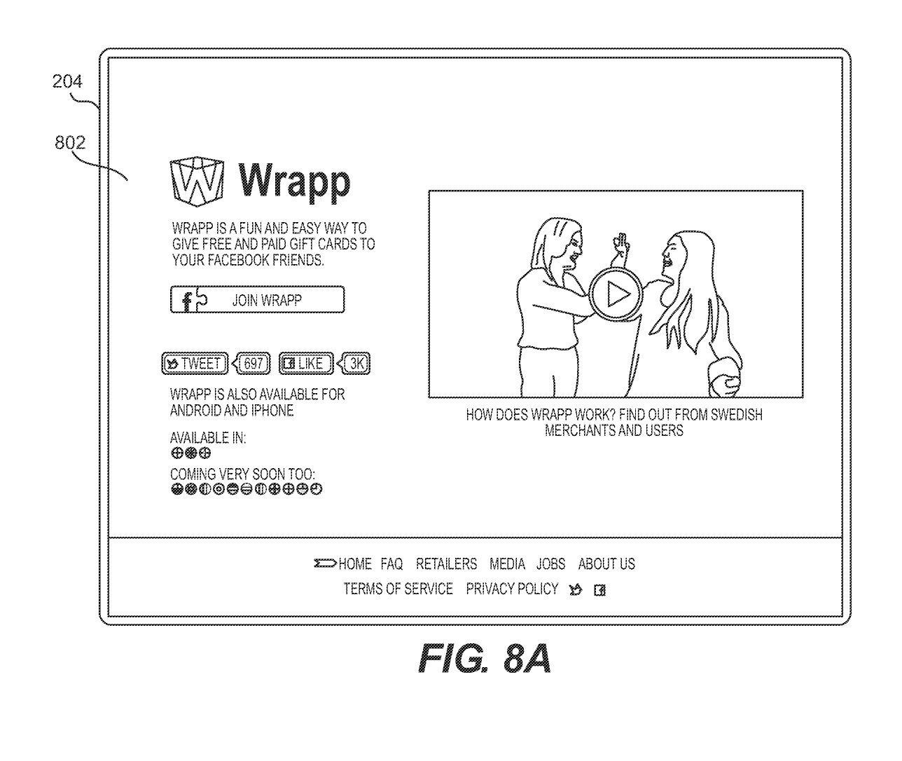

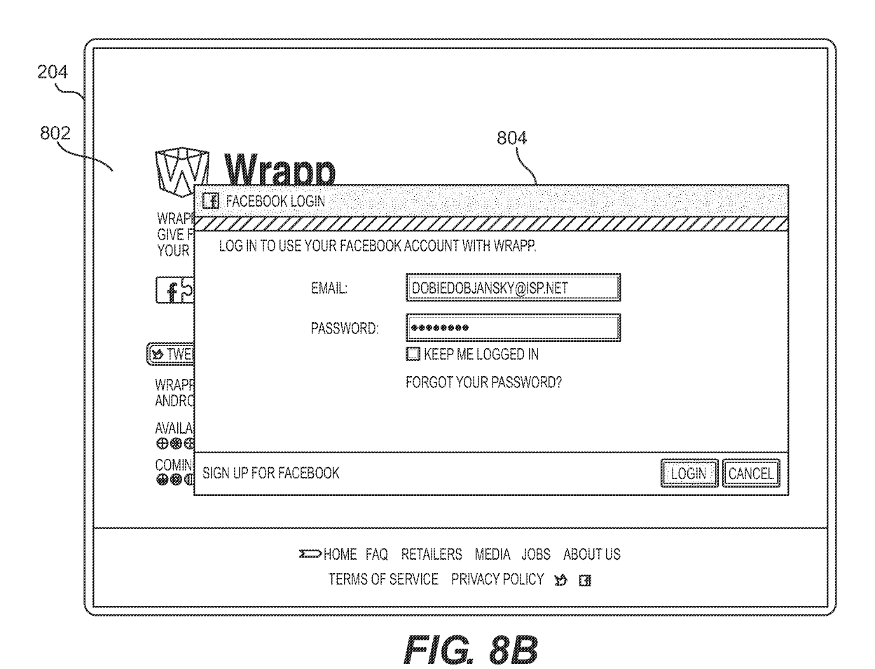

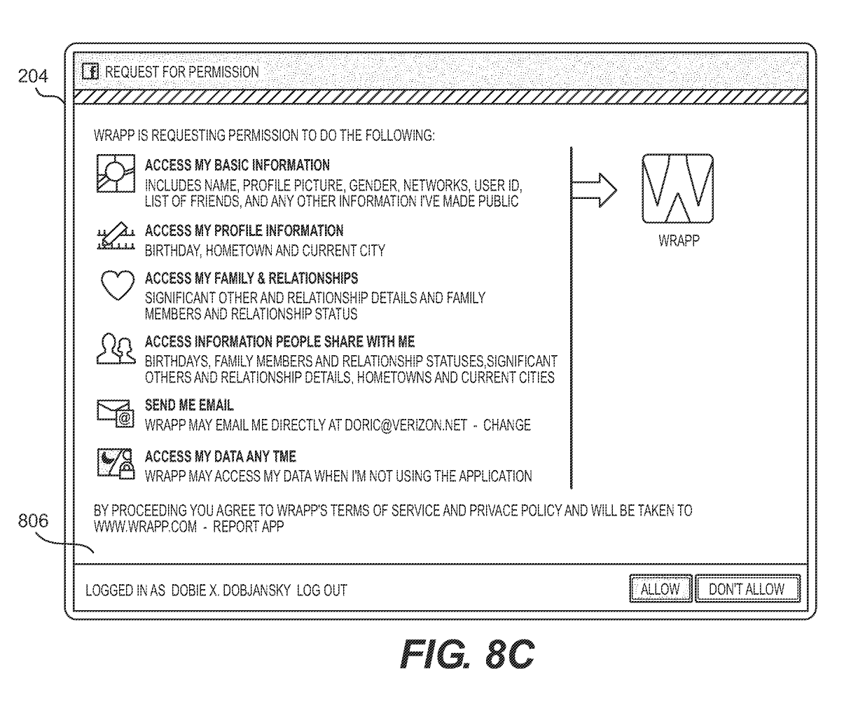

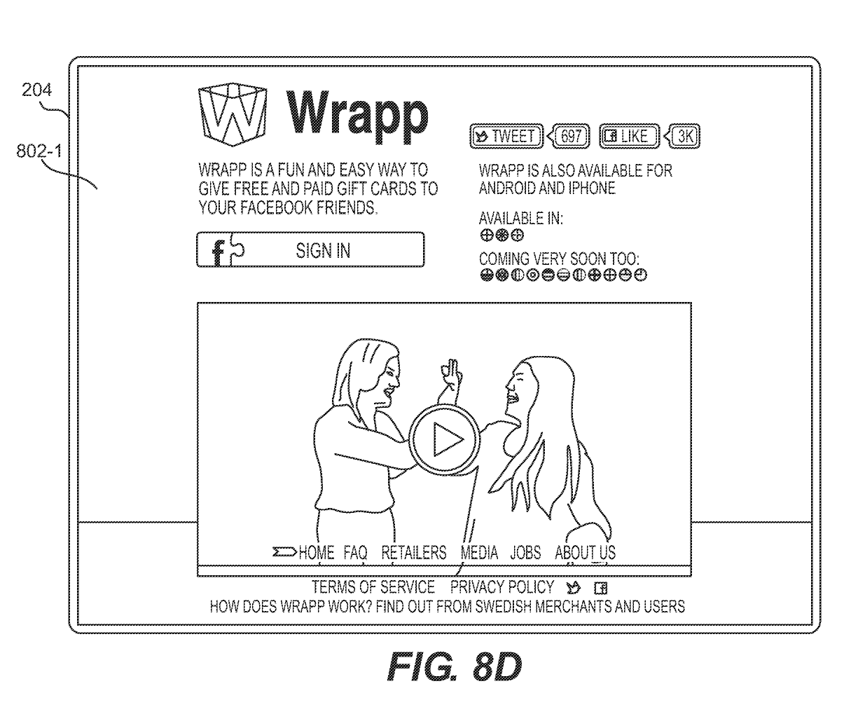

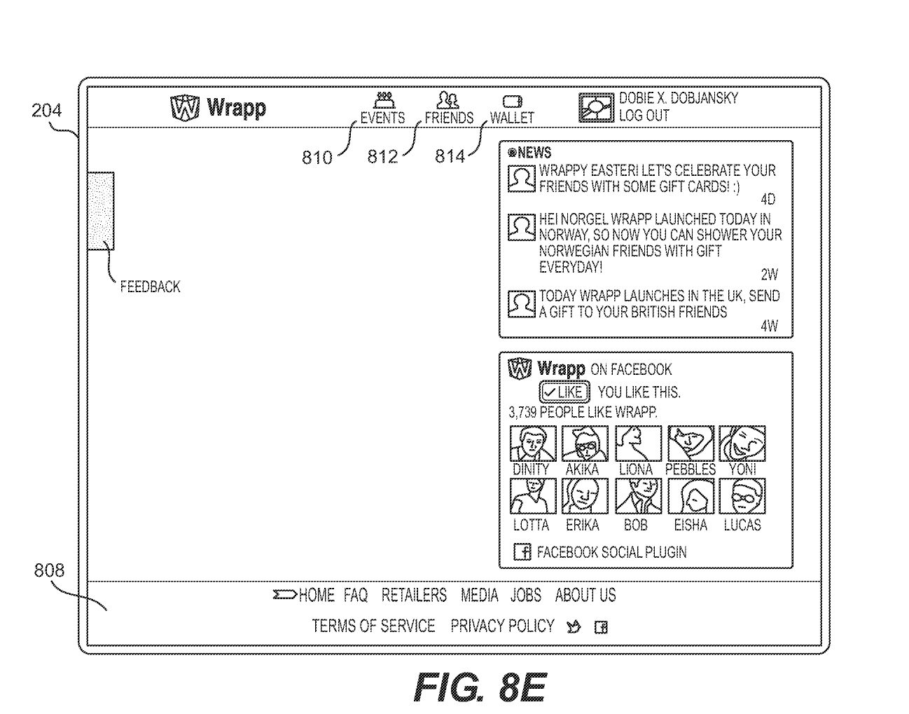

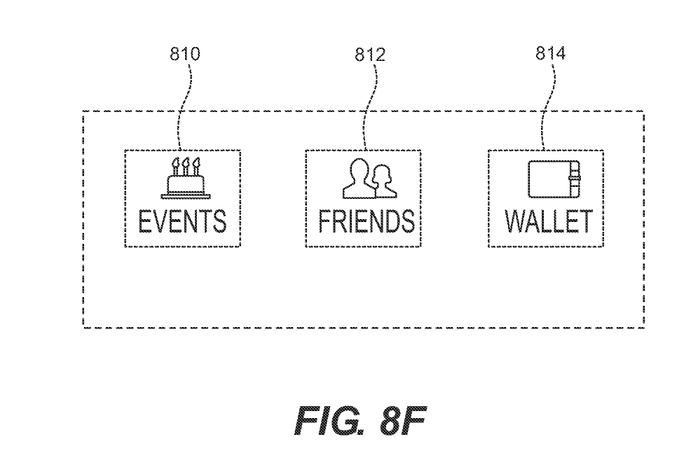

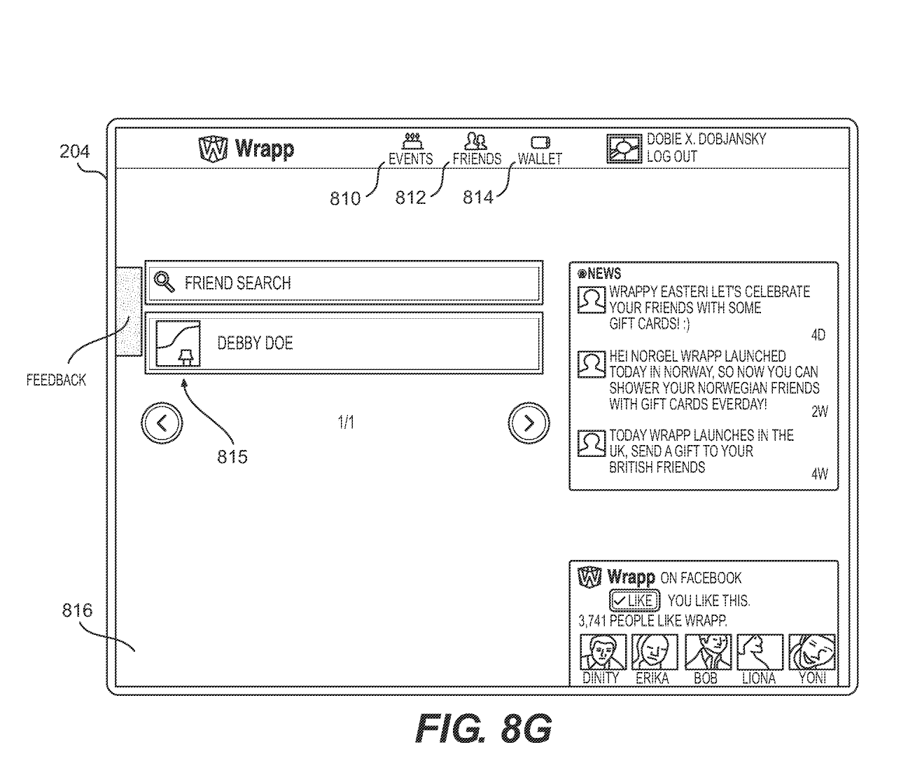

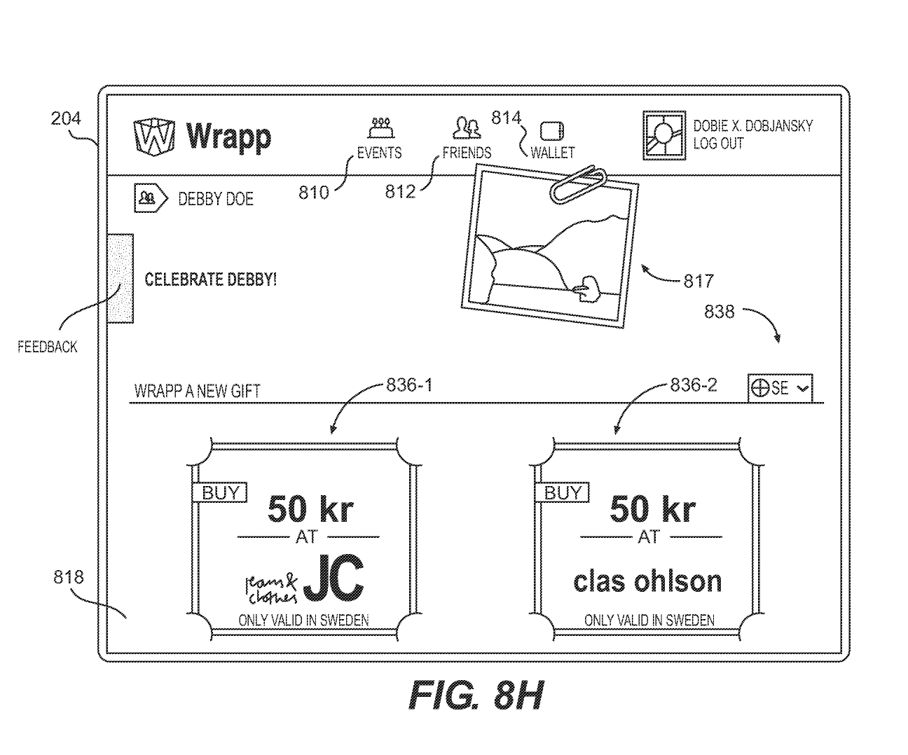

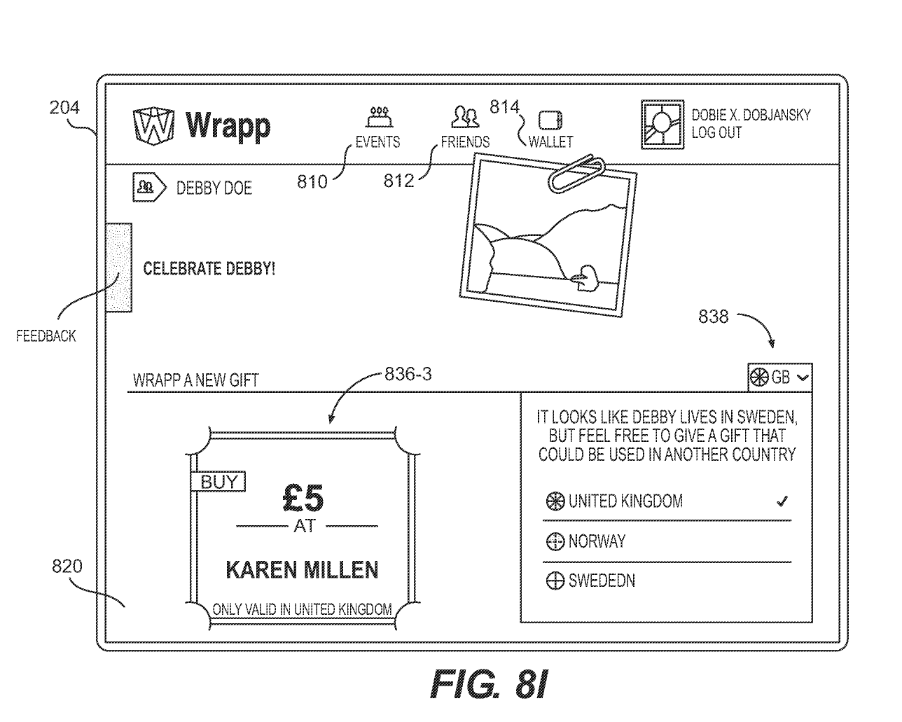

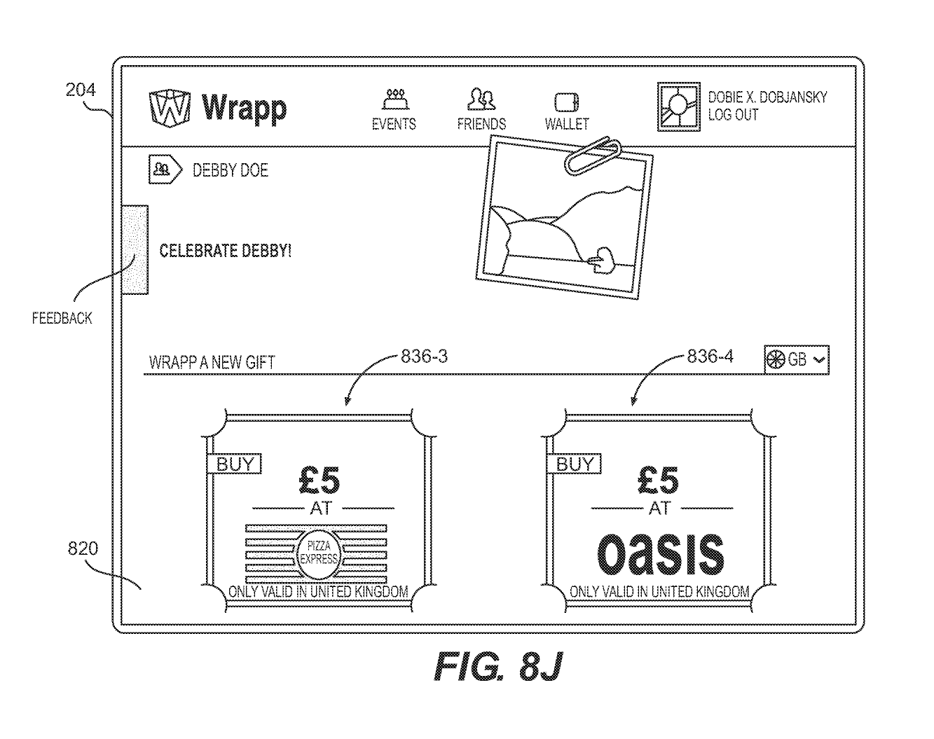

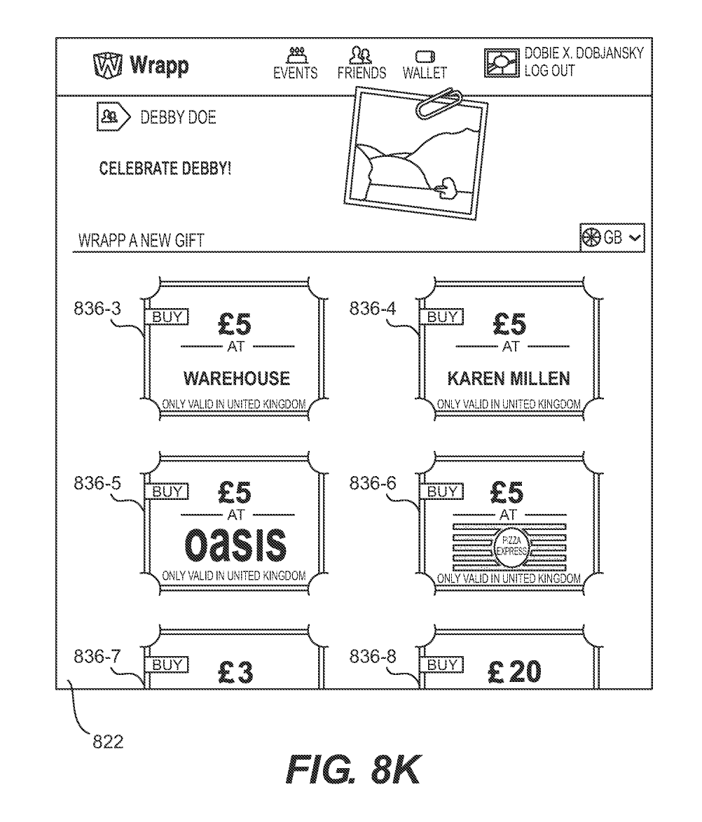

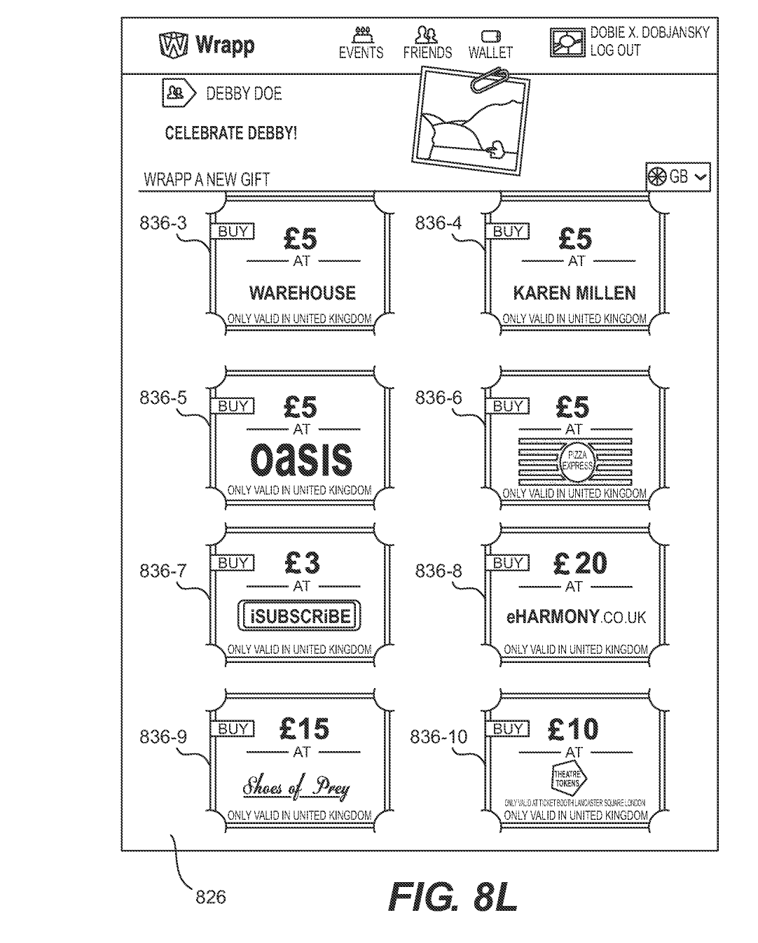

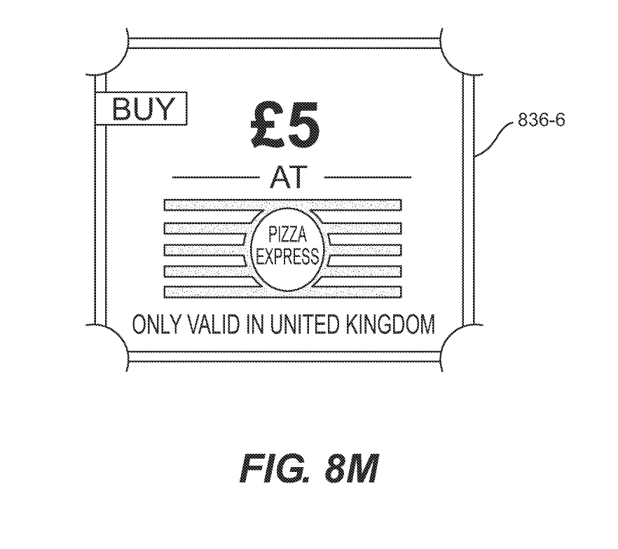

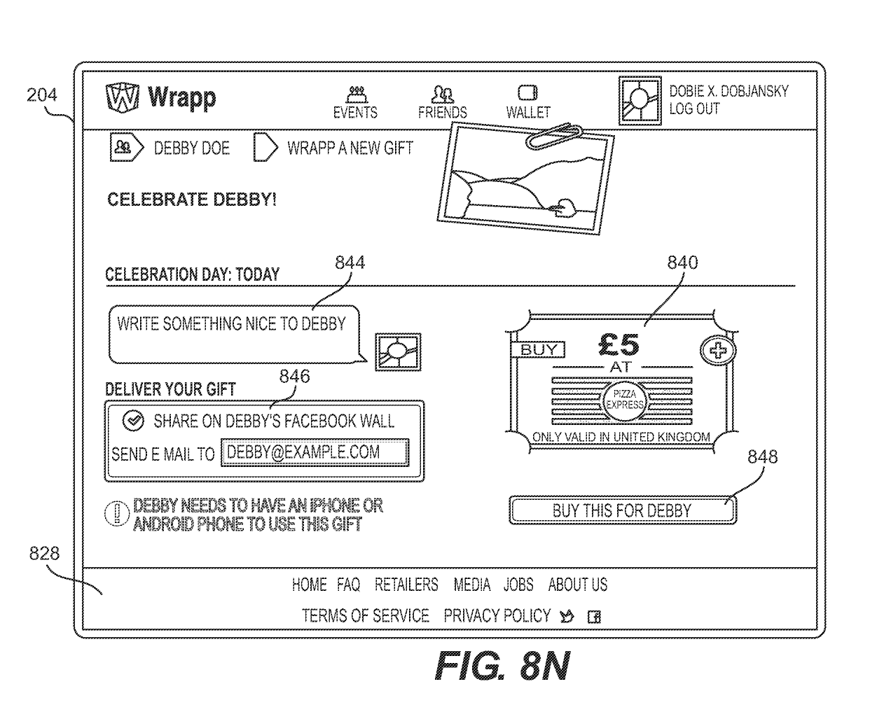

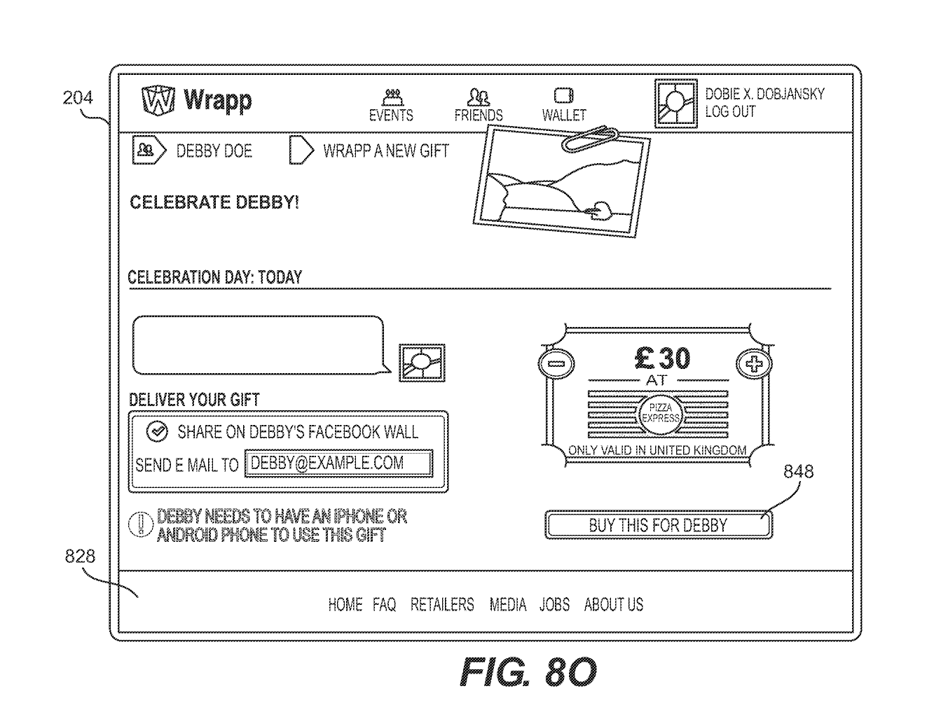

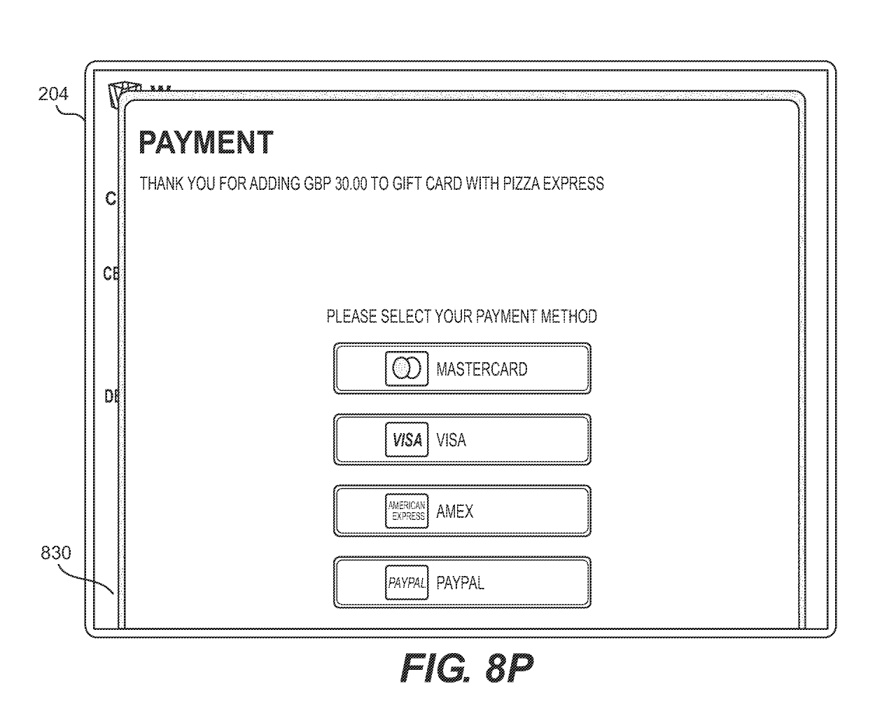

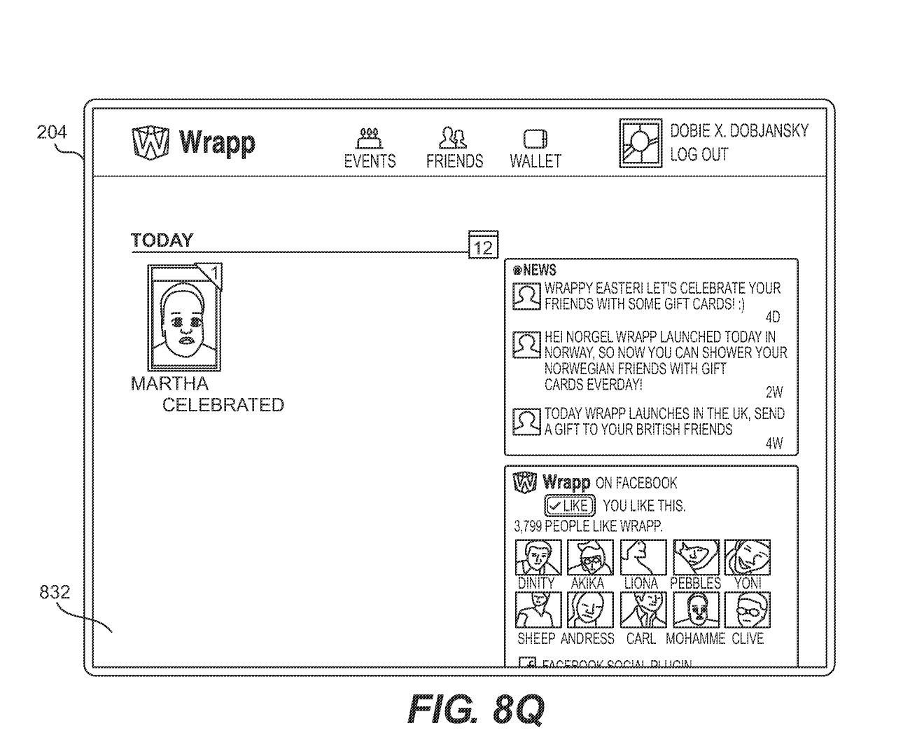

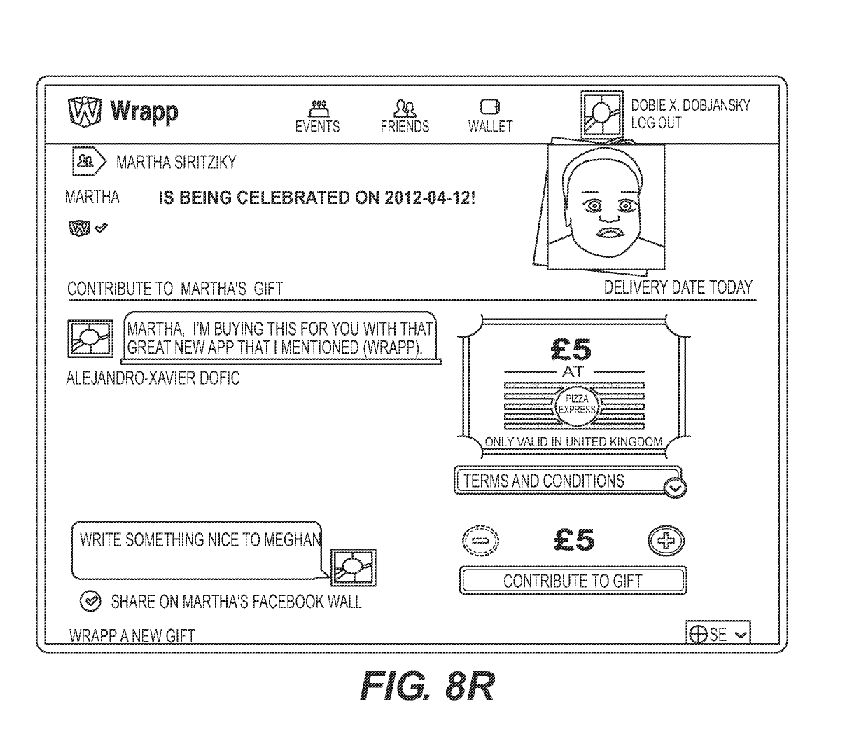

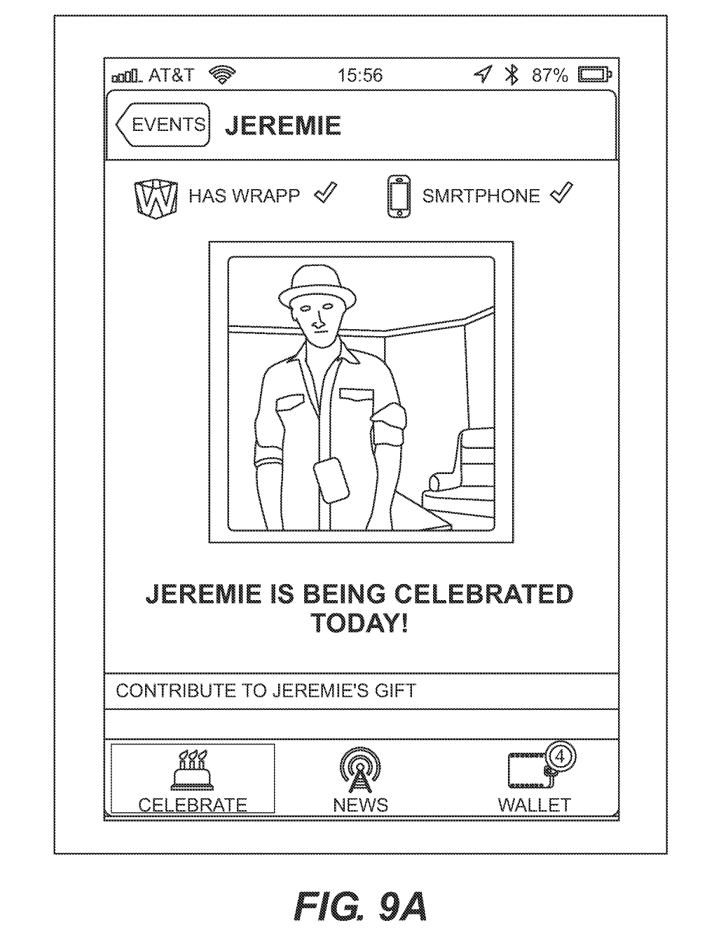

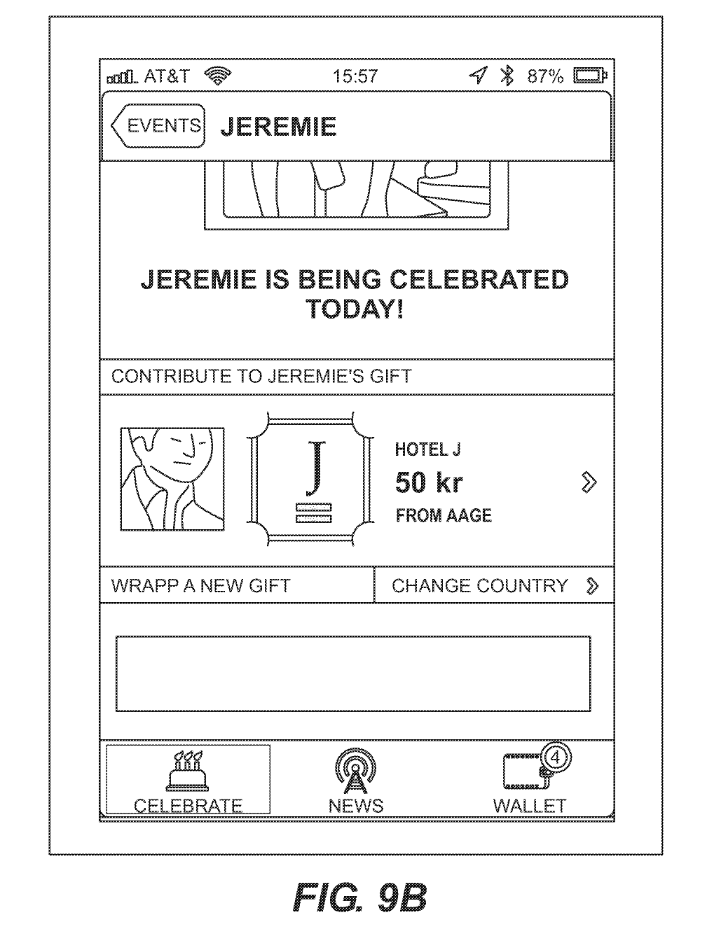

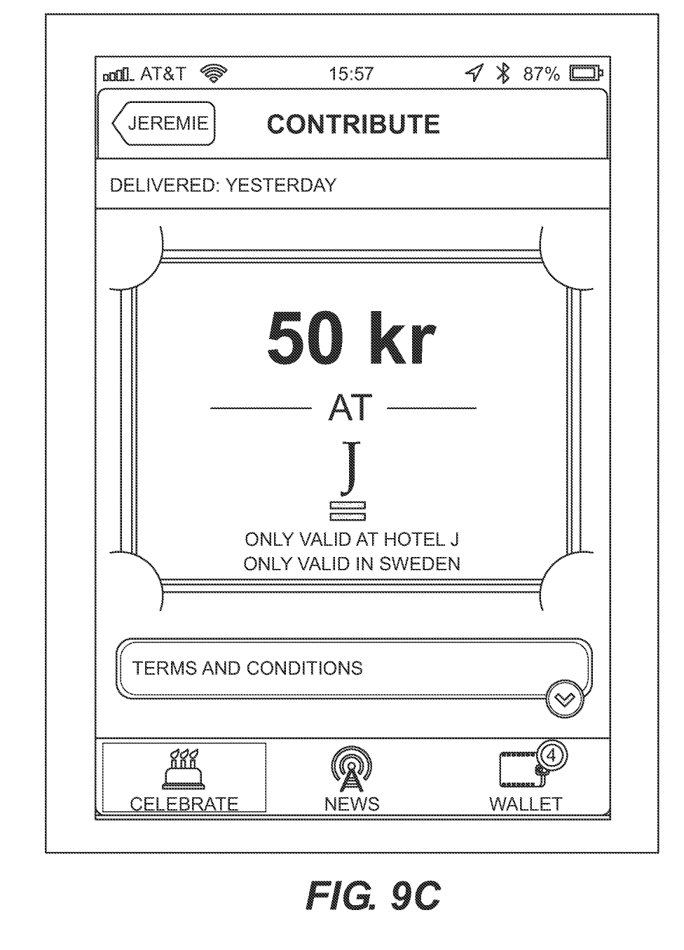

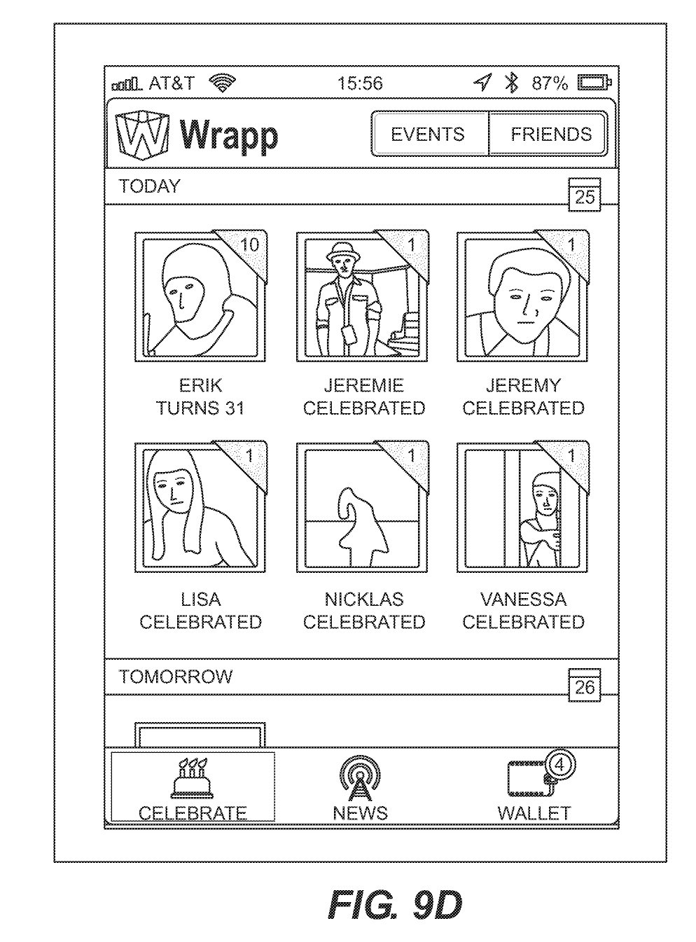

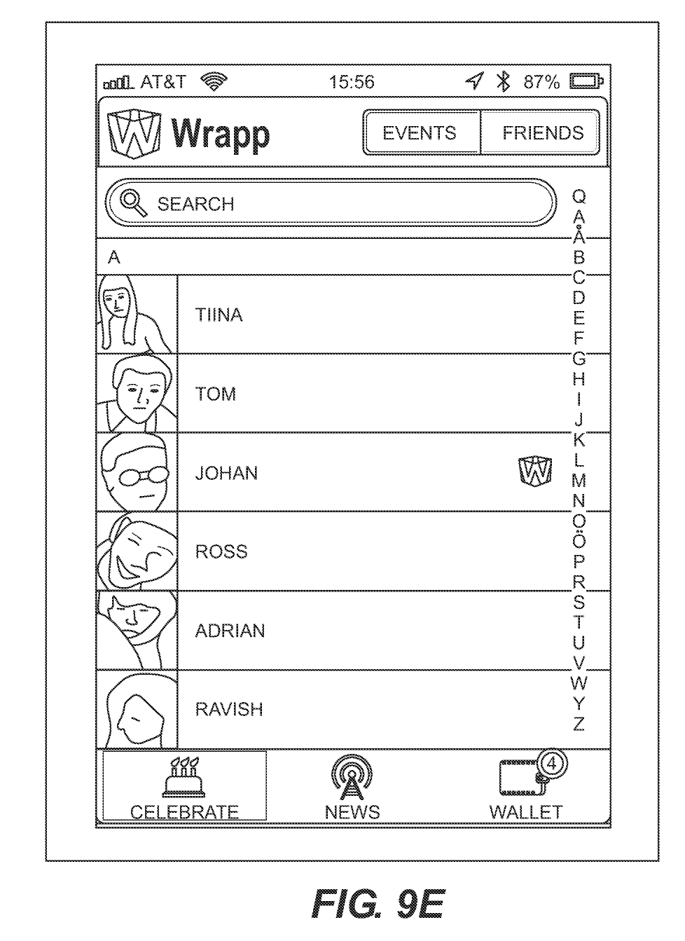

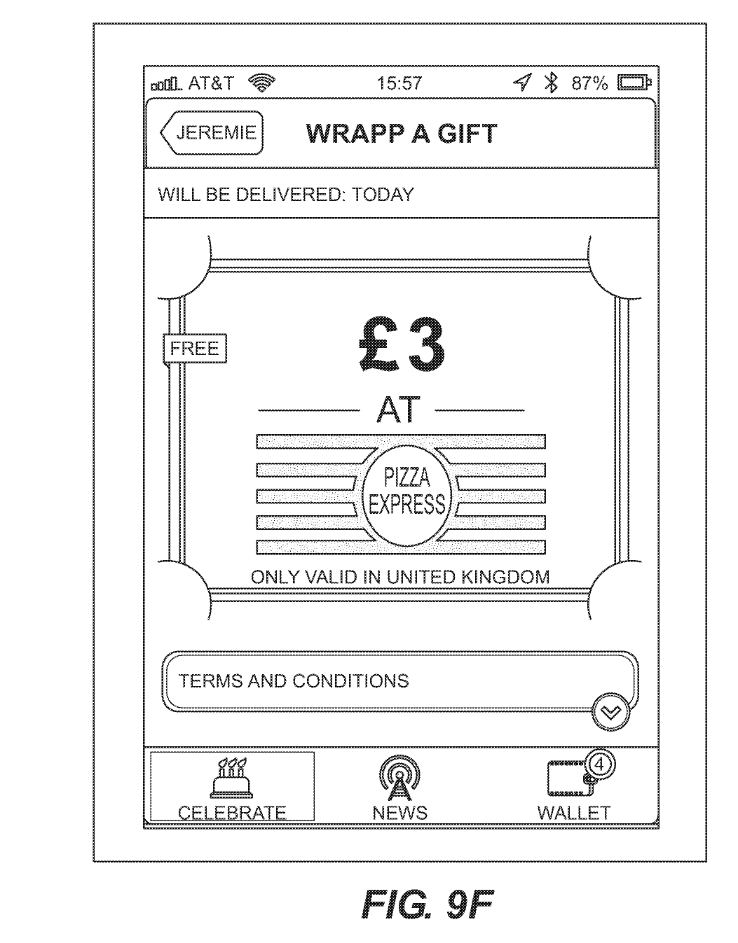

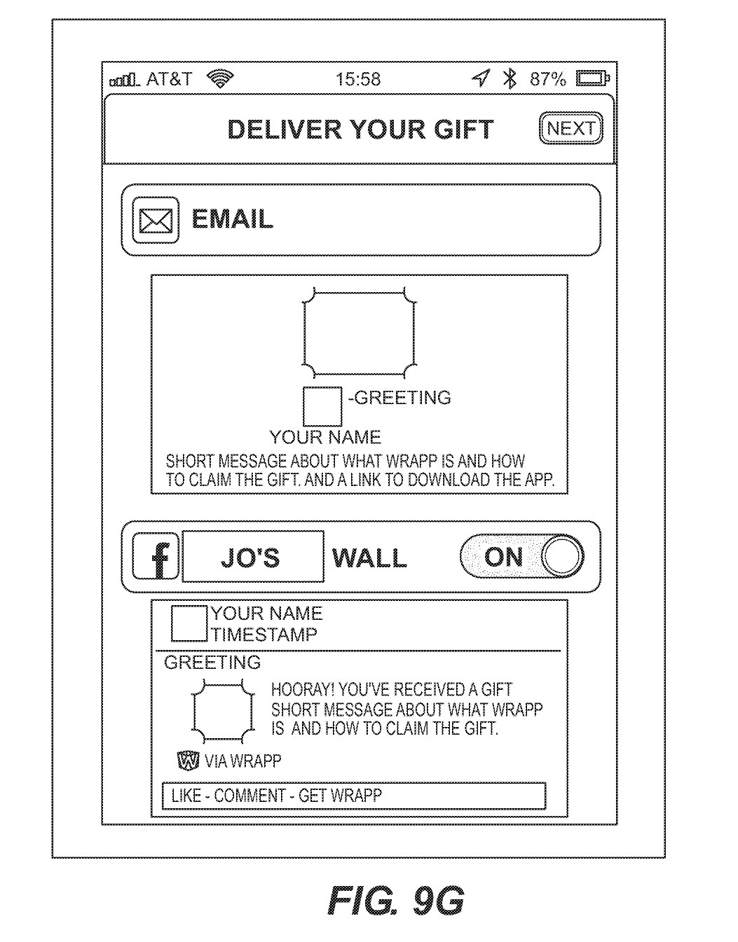

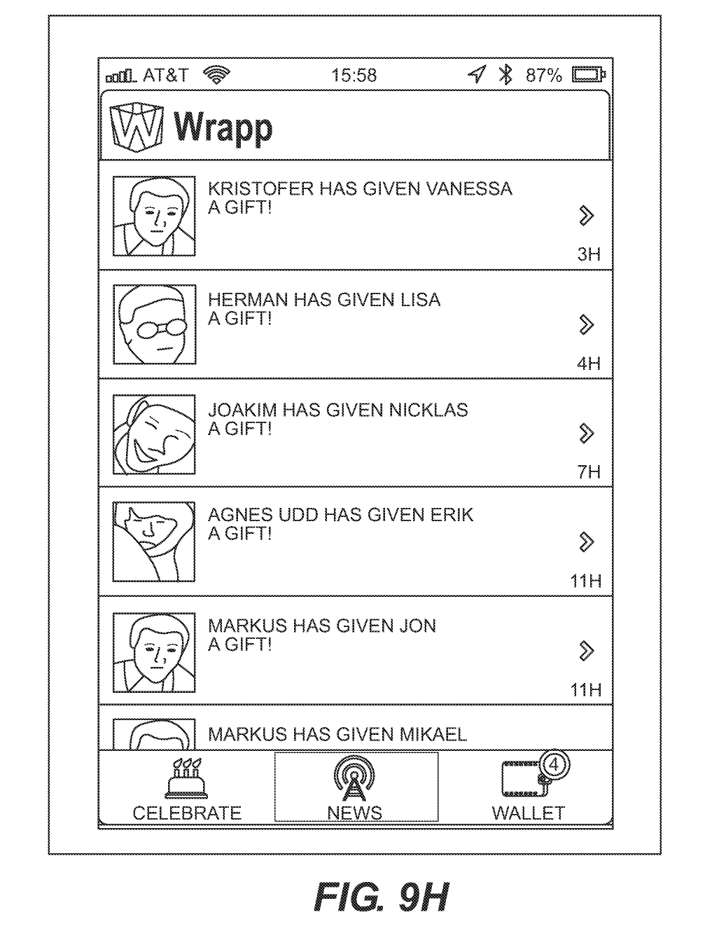

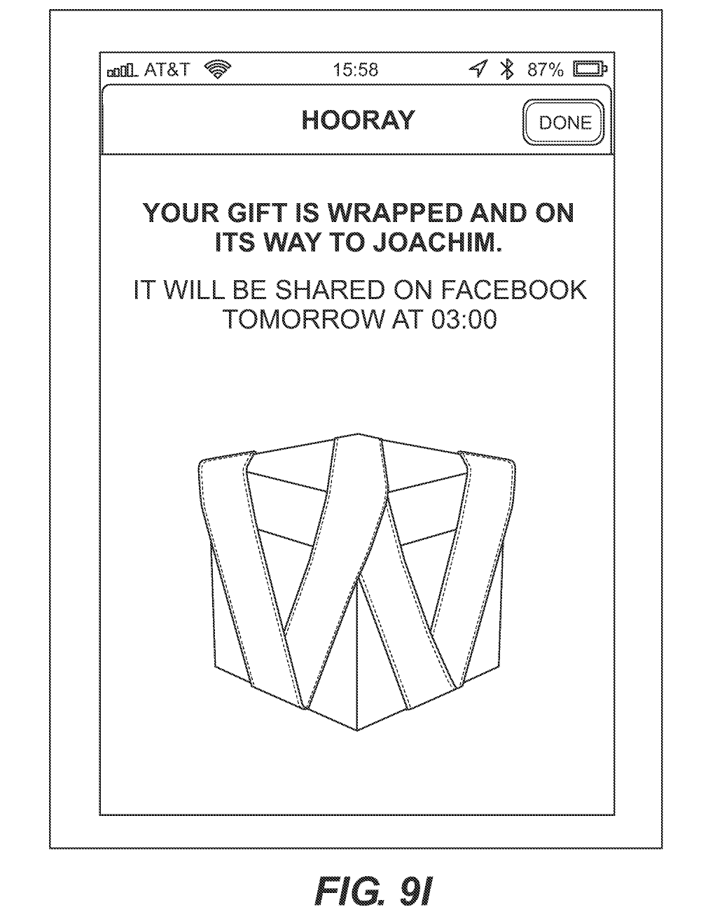

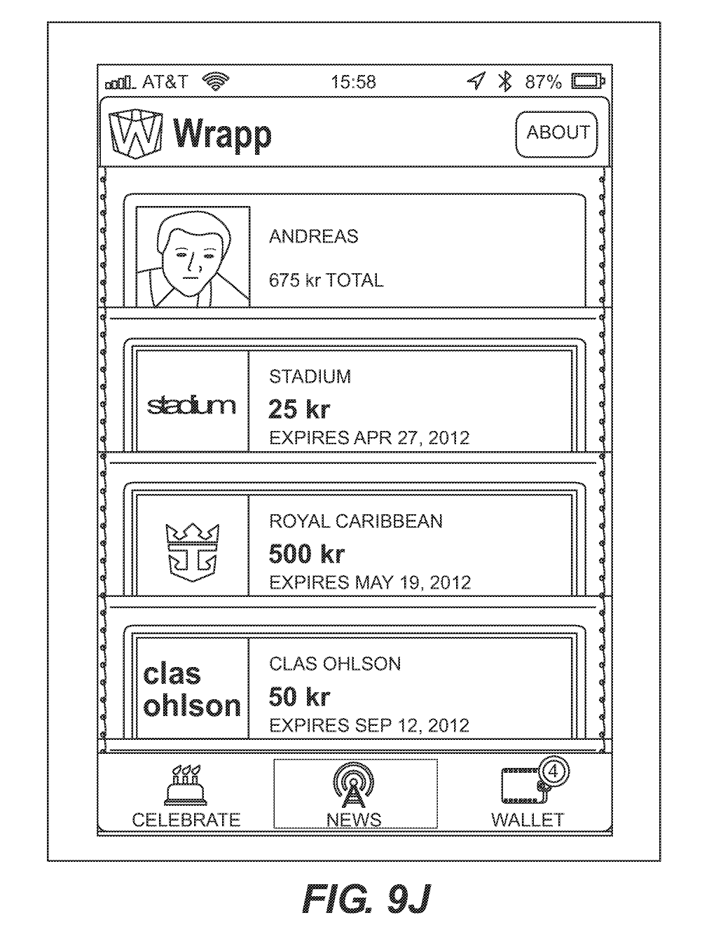

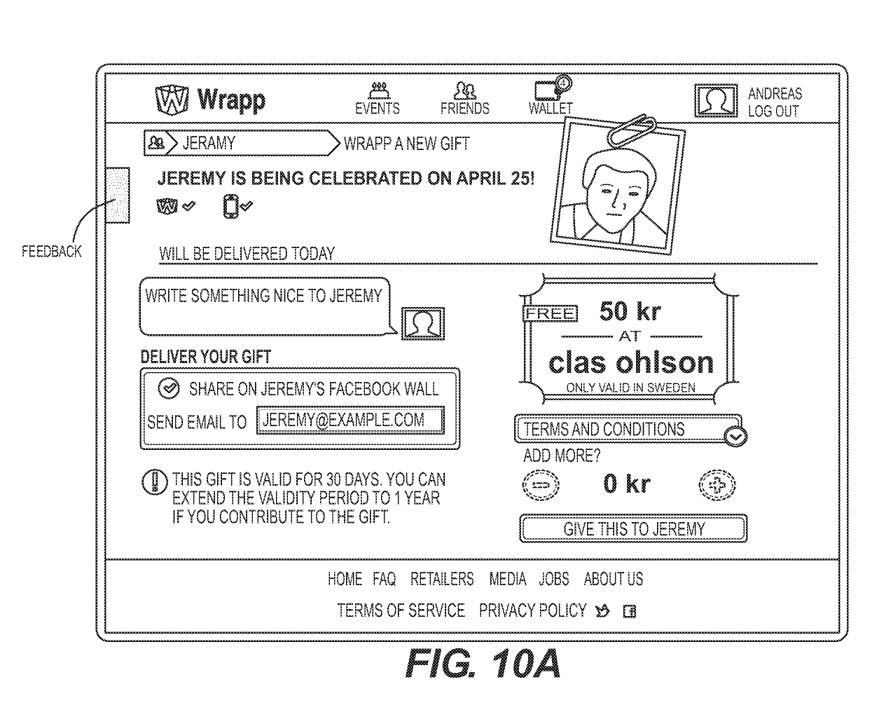

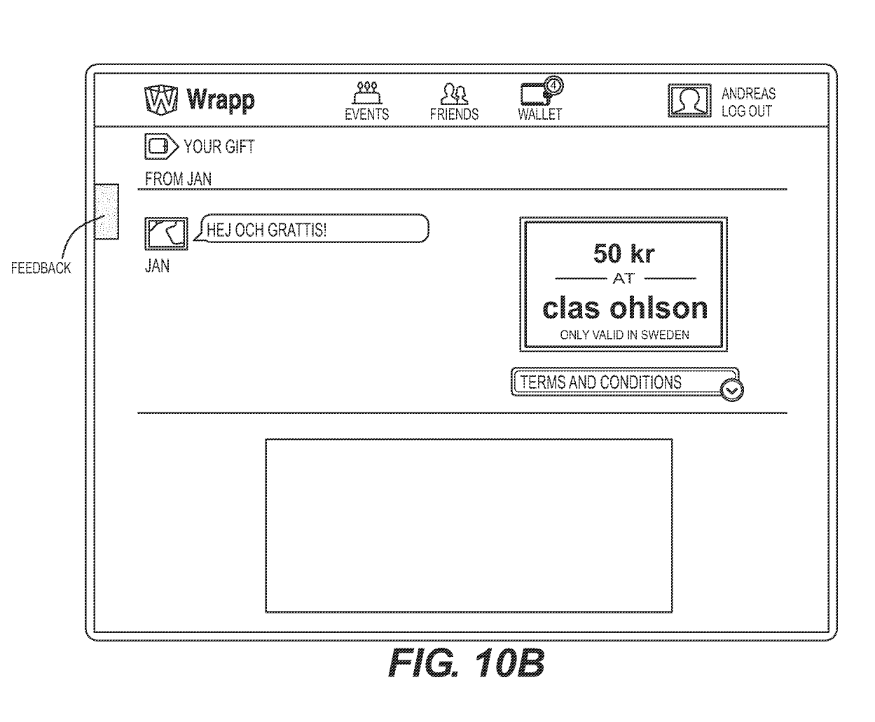

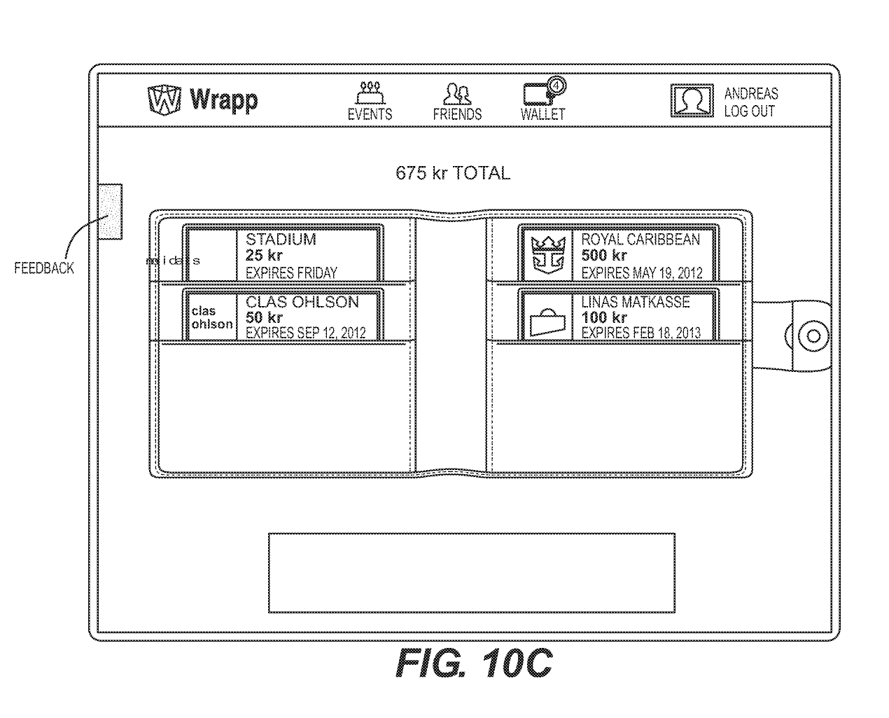

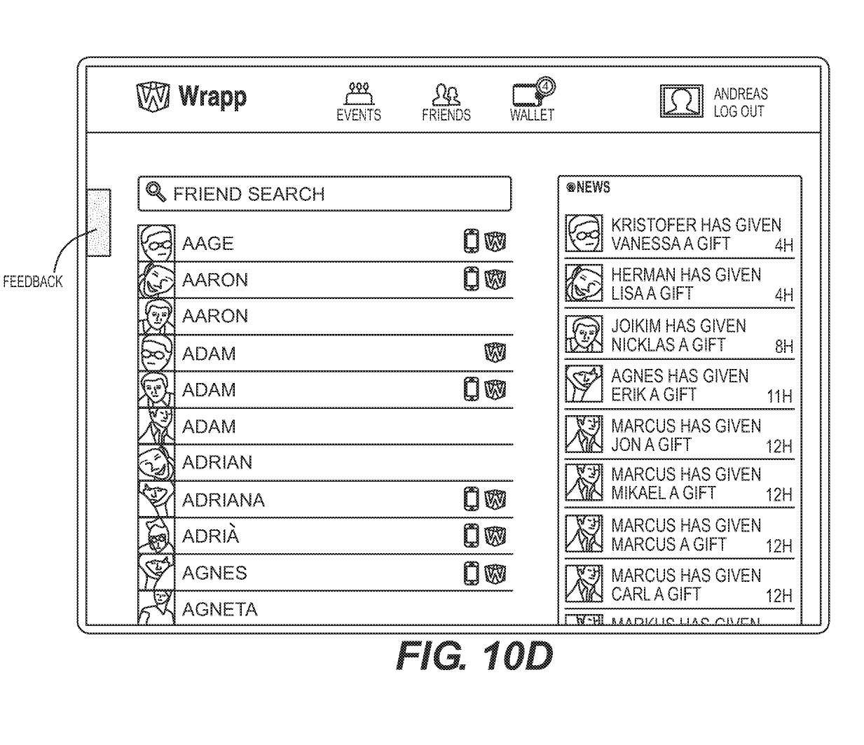

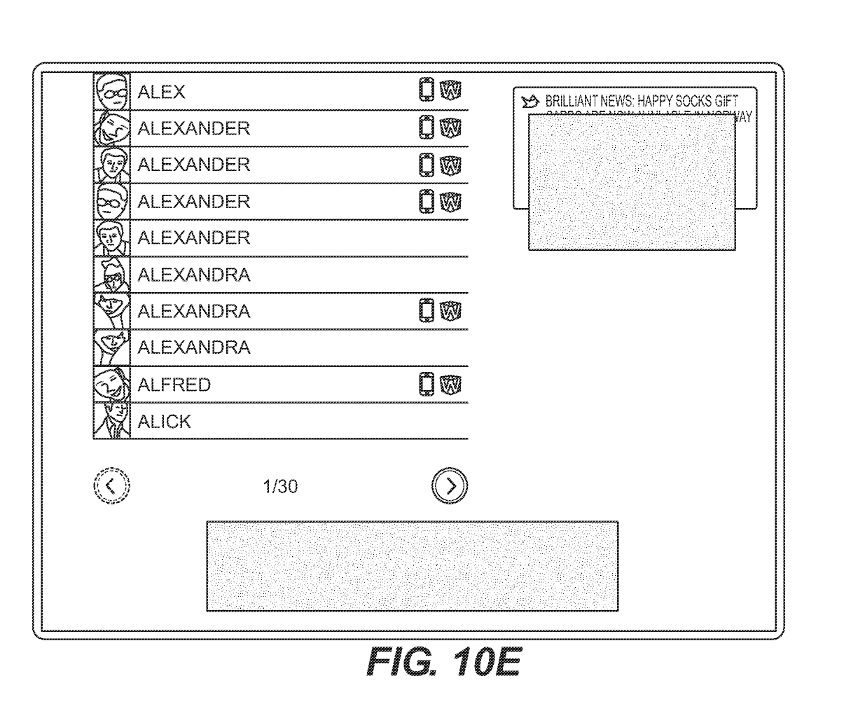

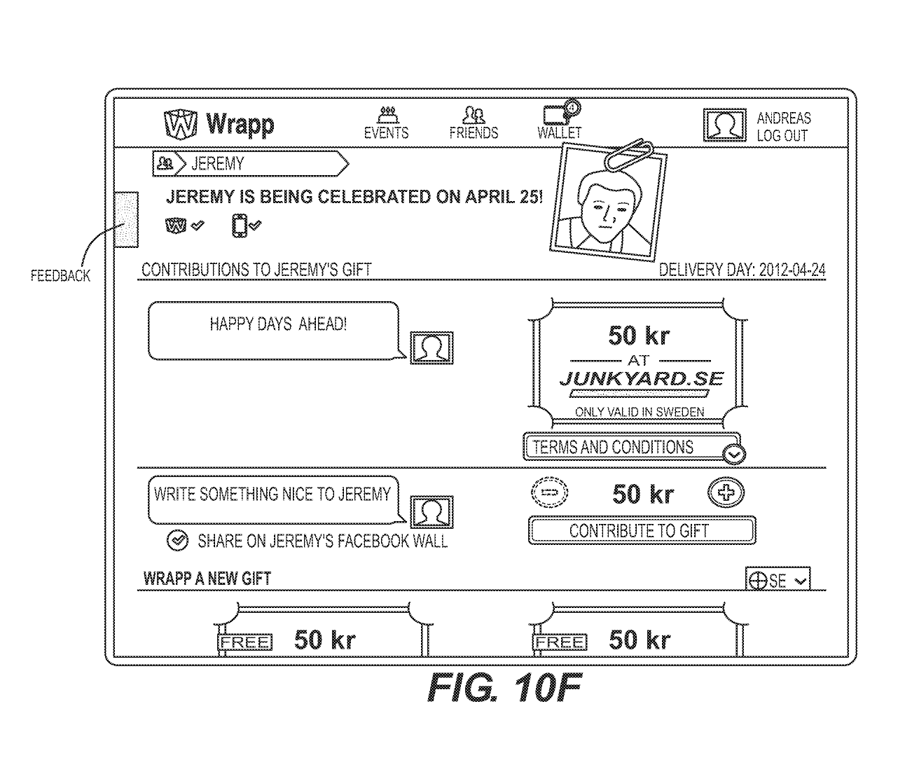

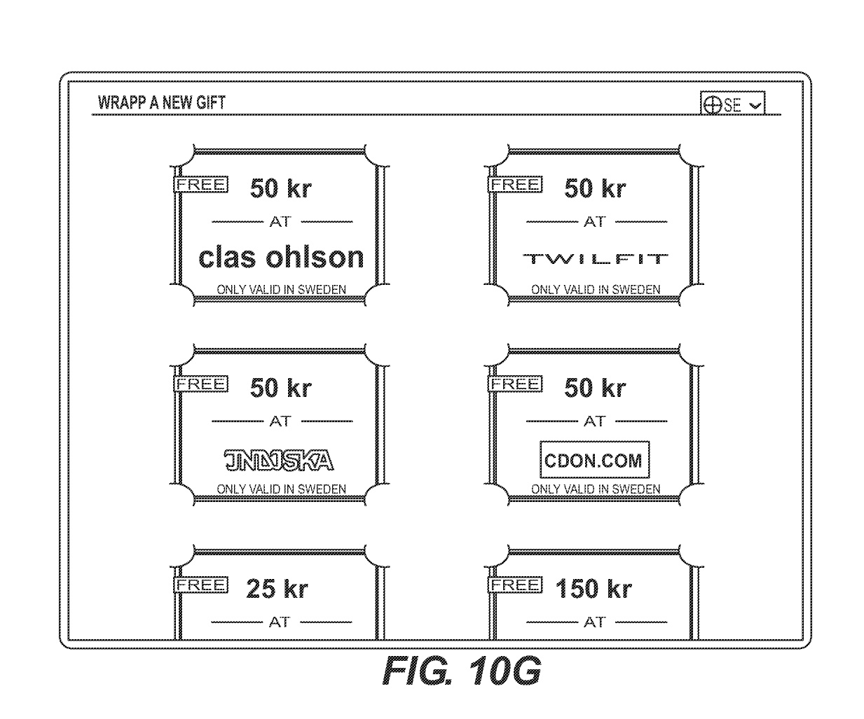

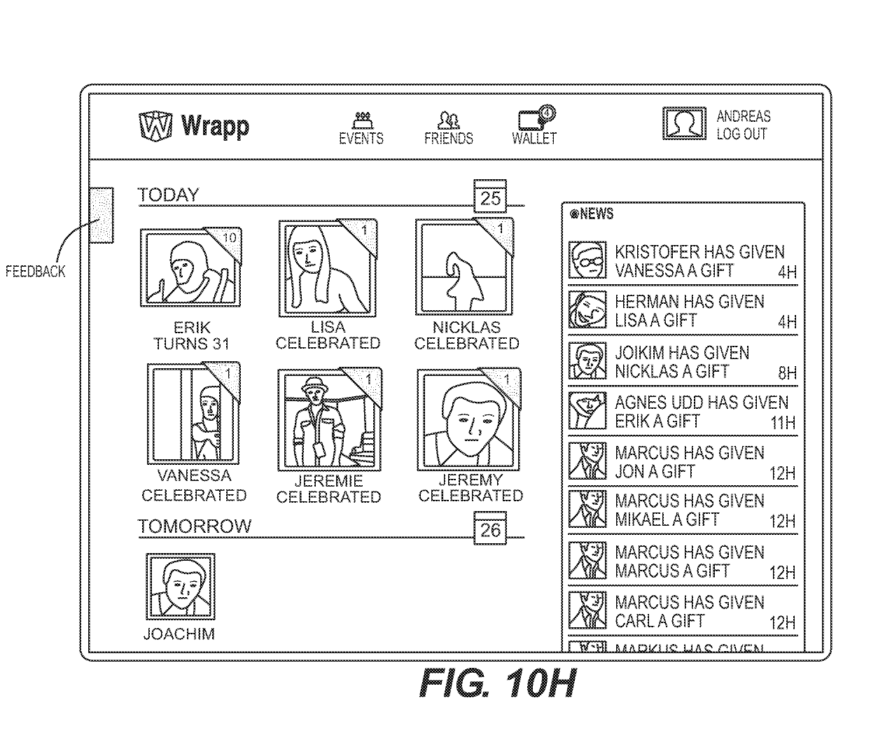

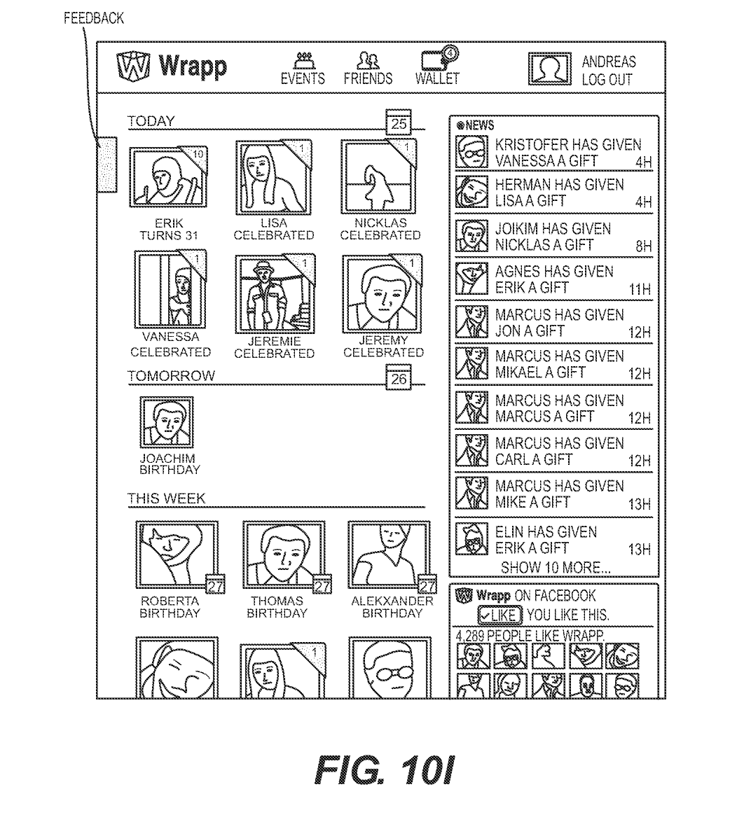

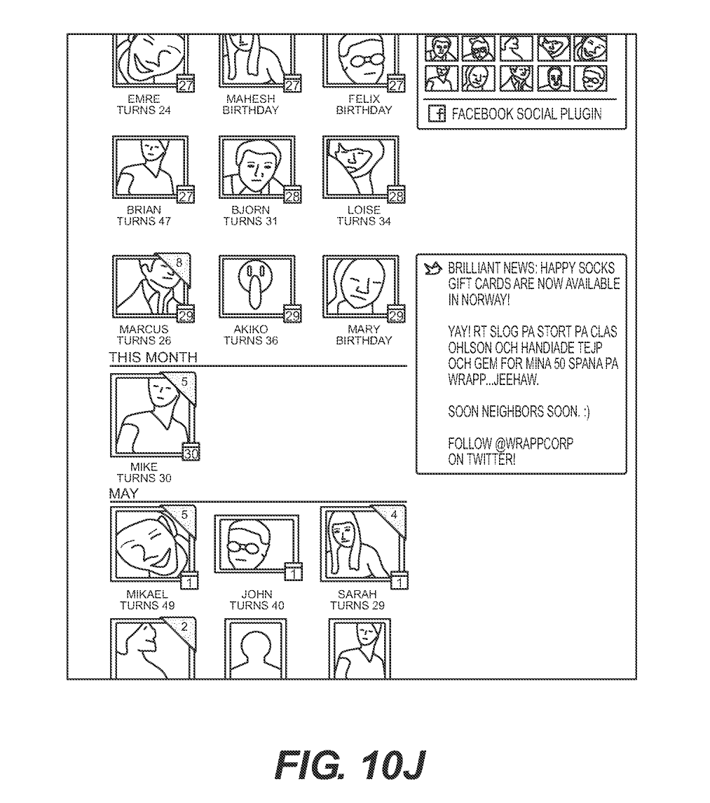

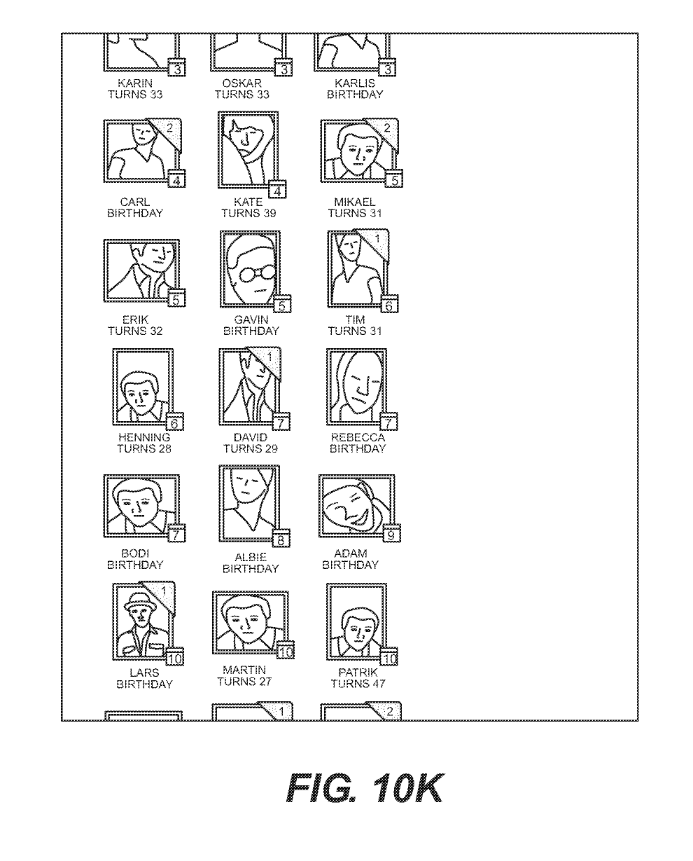

FIGS. 8(a)-8(o), 9(a)-9(j) and 10(a)-10(k) depict aspects of the graphical user interface (GUI) of exemplary embodiments of a gifting system 102. FIGS. 8(a)-8(o) and 10(a)-10(k) depict an exemplary GUI such as may be implemented on a computer device such as a personal computer and the like via a web interface. FIGS. 9(a)-9(j) depict exemplary aspects of a GUI such as may be implemented on a computer device such as a smartphone (e.g., an iPhone or Android or the like) using a device-specific application.

FIG. 8(a) depicts a web page 802 (corresponding to GUI 602) of a gifting system 102. This web page is displayed, e.g., on a display device 530 of a user's computing system 500 (this display may be, e.g., the screen 562 of the device 560 shown in FIG. 5(f) or the screen 566 of the device 564 shown in FIG. 5(g)). In the example shown the gifting system is called “Wrapp”. As seen on the web page 802, the gifting system provides users with an opportunity/option to join the gifting system through the Facebook social networking service via a link denoted “Join Wrapp”. When a user selects that link (which corresponds to register region 604 in FIG. 6(a)), the user is directed to another web page, preferably via a secure (HTTPS) connection. For example, in a currently preferred implementation, the rectangular region denoted “Join Wrapp” corresponds to a link to a location at haps://www.wrapp.com/app where the user may register.

When a user selects the link “Join Wrapp”, the system determines whether or not the user is currently already logged in to the Facebook SNS on this computing device. If not, the user is provided with an option to logon to their Facebook account. This option may be provided as a pop-up window 804 on the display, e.g., such as shown in FIG. 8(b).

While the system shown in FIG. 8(a) only shows a link to a one social networking service (Facebook), it should be appreciated that links may be provided for multiple social networking services and that a user may use the gifting system via multiple social networking services.

Once the user logs in to Facebook, or if the user is already logged in to a Facebook account on this computing device, the user is presented with an information screen in which the gifting system (in this case “Wrapp”) requests permission from the user regarding the user's Facebook account. For example, in this case the system presents the user with the screen 806 shown in FIG. 8(c).

The gifting system 102 preferably obtains certain information about the gift giver from the SNS(s) with which the gift giver registers. In addition, the gifting system preferably needs to be able to do certain things on the gift giver's behalf, using the registered SNS(s). In particular, the gifting system preferably needs to be able to access the gift giver's friend list and other data from the registered SNS(s), and the gifting system preferably needs to be able to write or post information to the SNS(s) on the gift giver's behalf.

In this example, as shown in FIG. 8(c), the gifting system 102 requests the user's permission to do the following with respect to the user's social networking service (in this case, Facebook):
Access the user's basic information, including the user's name, profile picture, gender, networks, user ID, list of friends, and any other information the user has made public.
Access the user's profile information, including the user's birthday, hometown and current city
Access the user's family and relationships, including significant other and relationship details and family members and relationship status
Access information people share with the user, including: birthdays, family members and relationship statuses, significant others and relationship details, hometowns and current cities
Send email to the user
Access the user's data any time, including when the user is not using the application.

It should be appreciated that different and/or other information may be requested and obtained by the gifting system about the user. For example, the SNS may request permission to post on the user's behalf, including posting of status updates, photos and other information.

In some cases the gifting system may only ask for certain permission as that permission is needed. For example, in some cases the system may not need the user's permission to post on the user's behalf unless a gift is purchased.

Those of skill in the art will realize and understand, upon reading this description, that not all of the information listed above (and shown in FIG. 8(c)) need be obtained or used by a gifting system 102. It should also be appreciated that the gifting system may obtain information about a user from other sources (external to the social networking service) or from other users of the gifting system. For example, the system may get information for a user profile, from user email accounts, from the user's calendar, and from the user's contacts.

As shown on the page 806 in FIG. 8(c), the user may choose to allow or not allow the gifting system 102 the requested access permissions with respect to that user's social networking service. If the user selects the region of the screen denoted “Don't Allow” then the user is returned to the screen 802 shown in FIG. 8(a). The region denoted “Don't Allow” may be denoted “Leave App” or with some other denotation. If the user selects the region denoted “Allow”, then the user becomes registered with the gifting system 102 and is directed to the gifting system's web page for registered users (see screen/page 808 in FIG. 8(e)).

By proceeding, the user also agrees to the gifting system's terms of service and privacy policy.

If the user is already registered with the gifting system 102 when the user loads the gifting system's web page (or starts an application that presents the user with a GUI to access the gifting system 102), then (instead of asking the user to join the system), as shown in FIG. 8(d) the web page 802-1 offers the user the option to sign in to the gifting system via the SNS (in this case via Facebook). The web page 802-1 corresponds to the GUI 602, with the “sign in” region in FIG. 8(d) corresponding to the Login region 606 of FIG. 6(a).

Once the user is registered and logged in to the system, with reference to the GUI 602 in FIG. 6(b), the user is presented with a graphical user interface 602 with various navigation regions 608. These preferably include an events region 610, a friends region 612, and a wallet region 614.

FIG. 8(e) depicts a particular web page 802 (corresponding to GUI 602 of FIG. 6(b)) of a gifting system 102. FIG. 8(f) shows various navigation regions from the page 808 shown in FIG. 8(e). In particular, FIG. 8(f) shows three rectangular regions 810, 812, 814, denoted, respectively, “Events”, “Friends”, and “Wallet”, which correspond to events region 610, friends region 612, and wallet region 614, respectively (see FIG. 6(b)). The regions are also denoted by icons, as can be seen in FIGS. 8(e)-8(f). While outlines of the regions are shown in FIG. 8(f) with dotted lines, it should be appreciated that the outlines of the regions are not generally visible on the actual web page (as can be seen, e.g., in FIG. 8(e)).

With reference to FIG. 6(b), the GUI 602 may also include a campaign list 613 including one or more campaigns 615-1, 615-2 . . . 615-k (collectively, campaigns 615). A campaign may be an offer from a merchant (e.g., a special price or discount such as a coupon). It should be appreciated that merchant offers may be free or highly discounted to some or all users, and may be used by merchants, e.g., to entice users to their stores and/or web sites.

In a current embodiment, a merchant-promoted campaign is a link (e.g., a URL) at on the gift system's GUI that a user can visit in order to receive a gift directly from the merchant (rather than from one of the user's friends). A campaign may be limited so that only a fixed and finite number of users may participate. The merchant may choose to advertise the link to the campaign in any way they want, for example on their Facebook page or in a member newsletter. In some embodiments, the campaigns may be provided on the GUI 602 before the user has signed in or registered.

Functionality associated with the campaigns may be implemented, at least in part, using the client-side campaign application(s) 552-j on the user's computing device (e.g., executing as one or more client-side processes including the corresponding client-side campaign process(es) 570-j on the user's computing device), alone or in interaction/combination with the backend campaign application(s) 554-j on one or more computer systems associated with the gifting system 102 (e.g., executing as one or more backend processes including the corresponding backend campaign process(es) 572-j on the one or more computer systems associated with the gifting system). As discussed below, aspects of the campaigns may also be implemented, at least in part, using the optimizer application(s) 554, executing, e.g., as one or more backend process(es) including, e.g., the optimizer process(es) 572-l, on one or more computer systems associated with the gifting system 102.

Those of skill in the art will realize and understand, upon reading this description, that the system is not in any way limited by the manner of naming or denoting any particular region or by the shape or size of any particular region, nor is the system in any way limited by the location of any regions.

Each region may have an action (or link) associated therewith, such that when a user selects that region the corresponding action (or link) is performed (or followed).

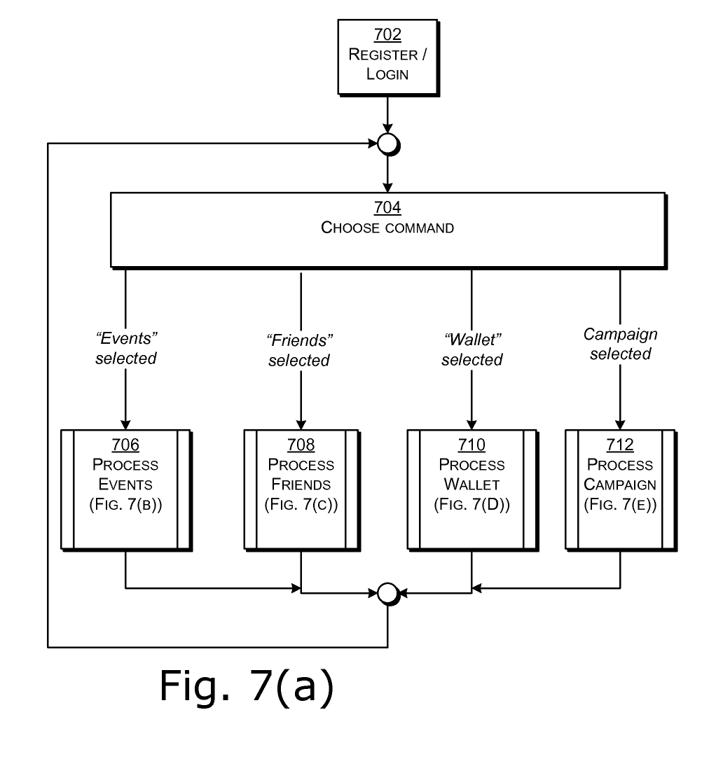

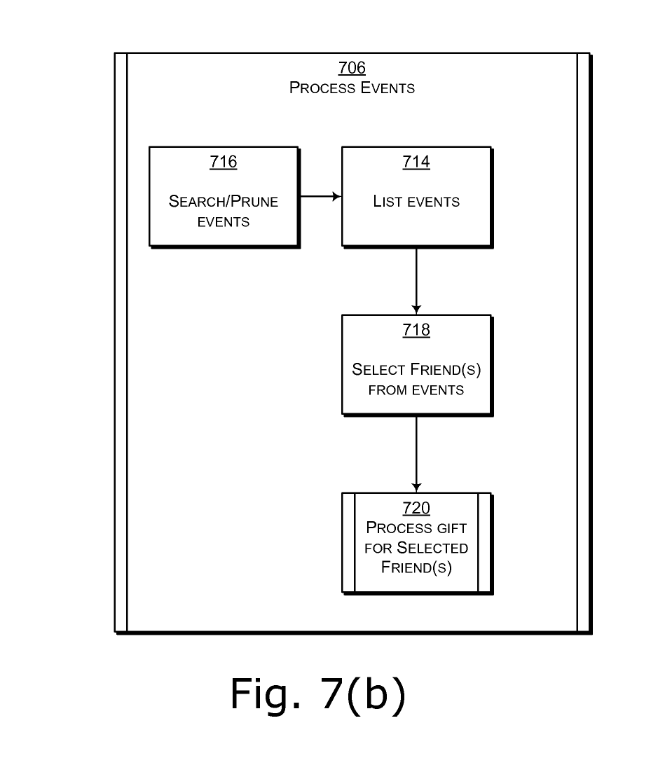

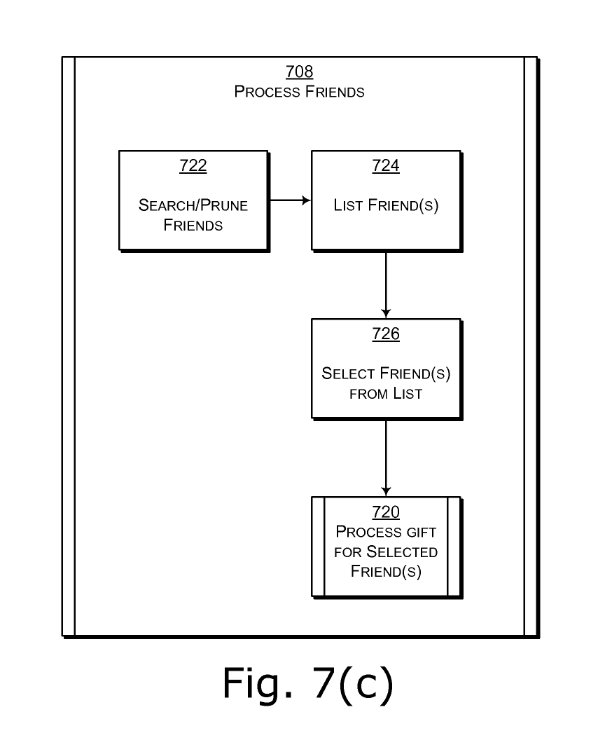

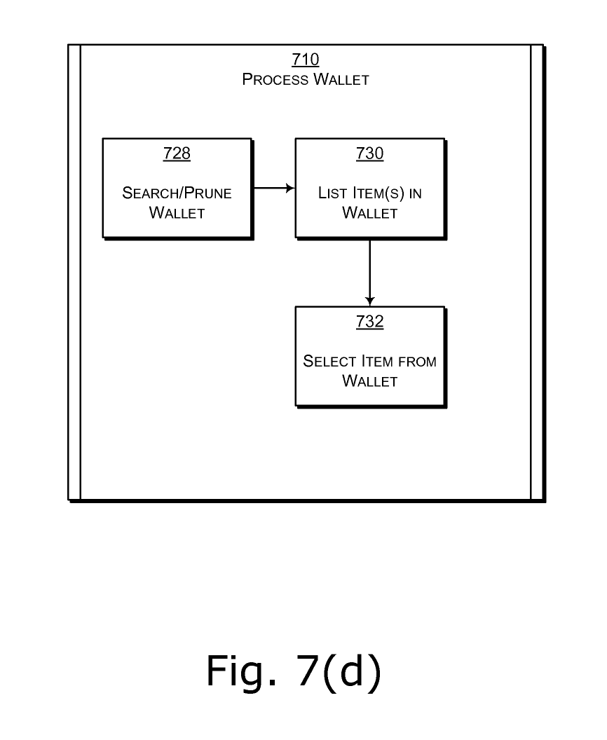

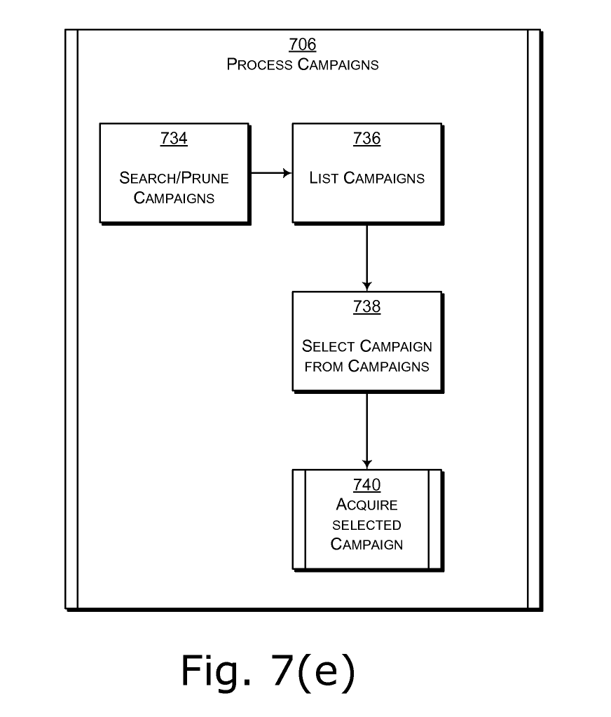

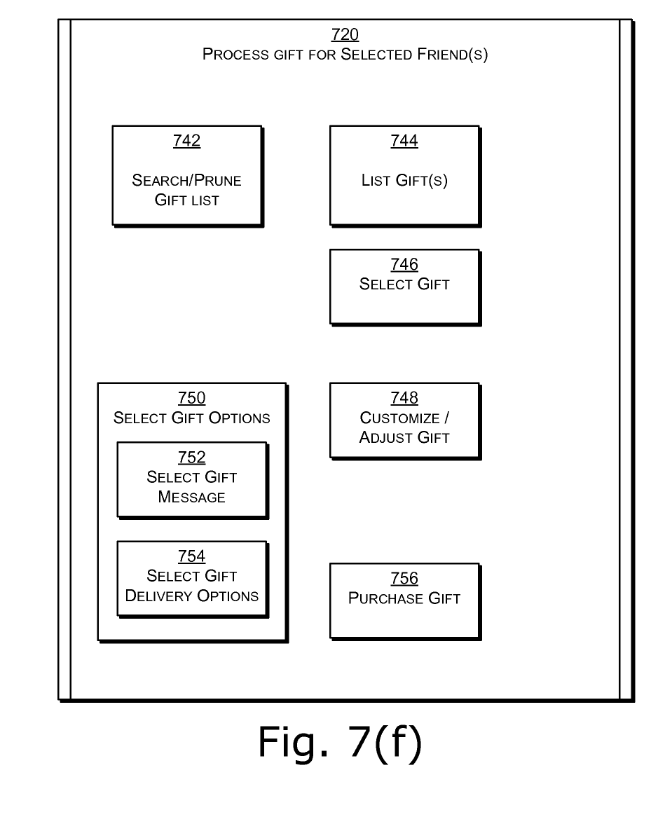

As noted, the GUI 602 and the functionality associated therewith may be implemented, at least in part, using client-side GUI application(s) 552-b on the user's computing device (e.g., executing as one or more client-side processes 570, including the corresponding client-side GUI process(es) 570-b on the user's computing device). With reference now to the flowchart in FIG. 7(a), the functionality of the GUI may be as follows: the user registers and/or logs in to the system via the GUI (at 702, and FIG. 6(a)), and may then choose a command (at 704) using/selecting the various regions (“Events” 610, “Friends” 612, “Wallet” 614, or a campaign 615 from the campaign list 613).

With reference now to FIGS. 6(b)-6(e) and 7(a)-7(e), when the user selects the “Events” 610 region, functionality associate with that region is performed (“Process events” 706, FIG. 7(b)). This functionality may be implemented, at least in party, by the client-side events application(s) 552-a (executing as one or more client-side processes 570, including, e.g., client-side events process(es) 570-a, on the user's computing device) alone or in combination/interaction with backend applications including, e.g., the backend events application(s) 554-a (executing as one or more backend processes 572, including, e.g., backend events process(es) 572-a, on the on the one or more computer systems associated with the gifting system).

As shown in the flowchart in FIG. 7(b), when the user selects the events region 610, the user is provided with a list of events (at 714). The user may optionally (and if the feature is provided), search/prune the list of events (at 716). The user may then select one or more friends from the list of events (at 718) and may then process a gift for the selected friend(s) (at 720).

Thus, when a user selects the events region 610 of the GUI 602, the user is provided with a list of events 616 comprising zero or more events 618-1, 618-2 . . . 618-k (at 714). These events correspond to events such as holidays (e.g., Easter, Christmas, and the like), events on which gifts are typically given (e.g., Valentine's Day, Secretary's Day, and the like), and events that the gifting system determines from the user's information and the user's friends' information (e.g., friends' birthdays, anniversaries, and the like). In some embodiments the gifting system 102 may determine and retrieve upcoming events from a connected SNS or from the user's calendar in order to populate the events list 616. The events may be presented in a calendar ordering, preferably most recent first.

In some embodiments, the GUI 602 may also provide the user with an event search region 620 which the user may use to search for specific types of events (e.g., birthdays and the like) or for events on certain dates (at 716). It should be appreciated that different and/or other search criteria may be used, and that default search values/criteria may be applied. For example, a user may search for all friends having birthdays in the next week.

Functionality associated with the events may be implemented, at least in part, using client-side applications including the client-side events application(s) 552-a on the user's computing device (executing as one or more client-side processes 570, including, e.g., client-side events process(es) 570-a, on the user's computing device), alone or in interaction/combination with backend applications, including, e.g., the backend events application(s) 554-a on one or more computer systems associated with the gifting system 102 (executing as one or more backend processes 572, including, e.g., backend events process(es) 572-a, on the on the one or more computer systems associated with the gifting system). Aspects of the events may also be implemented, at least in part, using the client-side SNS interface application(s) on the user's computing device (executing as one or more client-side processes 570, including, e.g., client-side SNS interface process(es) 570-i, on the user's computing device), alone or in interaction/combination with backend SNS application(s) 554-i on one or more computer systems associated with the gifting system 102 (executing as one or more backend processes 572, including, e.g., backend SNS interface process(es) 572-i, on the on the one or more computer systems associated with the gifting system).

In a preferred implementation, the default result for the list of events is a list of the user's friends ordered by their birthdays, with soonest first.

In the example shown in FIG. 8(e), if a user selects the area/region 810 denoted “Events”, the user is shown a list of events. For example, the events may show the list of events in FIG. 8(q), with a single event for “Today” for a friend named “Martha”. FIG. 9(d) shows events on a screen of a smartphone or such device, listing six events for “Today” for friends “Erik”, “Jeremie”, “Jeremy”, “Lisa”, “Nicklas”, and “Vanessa”. Other events are shown below these for “Tomorrow” and so on, and the user can view these events using an appropriate interaction with the GUI shown in FIG. 9(d). FIGS. 10(h)-10(k) show the events for the same user, this time using a GUI on a screen of a computer device such as a desktop computer or an iPad.

With reference to FIGS. 6(d), 7(a) and 7(c), when a user selects the “Friends” region 612 of the GUI 602, functionality associate with that region is performed (“Process Friends” 708, FIG. 7(c)). This functionality may be implemented, at least in party, by the client-side friends application(s) 552-c (executing as one or more client-side processes 570, including, e.g., client-side friends process(es) 570-c, on the user's computing device) alone or in combination/interaction with the backend friends application(s) 554-c (executing as one or more backend processes 572, including, e.g., backend friends process(es) 572-c, on the on the one or more computer systems associated with the gifting system).

When a user selects the “Friends” region 612 of the GUI 602 the user is provided with a list 622 of that user's friends comprising zero or more friends 624-1, 624-2 . . . 624-m (at 724 in FIG. 7(c)). The list preferably includes the user's friends from the SNS(s) which the user has linked to the gifting system 102. In some embodiments, the GUI 602 also provides the user with a friend search region 626 which the user may use to search for specific friends or for friends matching certain criteria (at 722 in FIG. 7(c)). For example, the search mechanism may support searching for all friends of a certain gender, religion, age or age range, belonging to certain groups, having an upcoming birthday or anniversary, or the like. E.g., a user may wish to send gifts to all female friends over a certain age. If the user uses a customized search, then the user is presented only with friends satisfying that search. The system may support any kind of friend search through the GUI 602 and the friend search region 626. If a friend search region 626 is provided, default values will preferably be used to provide a list of all of the user's friends from SNS(s) which the user has linked to the gifting system 102.

With reference to the flowchart in FIG. 7(c), the user may select one or more friends from the list of friends (at 726) and may then purchase a gift for the selected friend(s) (at 720).

Functionality associated with the friends features may be implemented, at least in part, using the client-side friend application(s) 552-c on the user's computing device, alone or in interaction/combination with the backend friends application(s) 554-c on one or more computer systems associated with the gifting system 102. Aspects of the friends features GUI may also be implemented, at least in part, using the client-side SNS interface application(s) on the user's computing device (executing as one or more client-side processes 570, including, e.g., client-side SNS interface process(es) 570-i, on the user's computing device), alone or in interaction/combination with backend SNS application(s) 554-i on one or more computer systems associated with the gifting system 102 (executing as one or more backend processes 572, including, e.g., backend SNS interface process(es) 572-i, on the on the one or more computer systems associated with the gifting system).

Although the term “friends” is used in this description, it should be appreciated that the term refers more generally to people or entities with whom the user has a connection via a social networking service. Thus, e.g., for the LinkedIn SNS, a user's “friends” may correspond to that users connections. The system is not in any way limited by the term used to describe the people or entities with whom the user has a connection via a social networking service, and no actual friendship or association with the user, other than through the SNS, is needed or required.

With reference to the exemplary GUIs in FIGS. 8(e) and 8(g), in an actual embodiment, if a user selects the area/region 812 denoted “Friends”, the system presents the user with a list of some or all of the user's friends from the SNS. For example, as shown in FIG. 8(g), when the user selects the region 812, the system presents the user with a list of some or all of the user's Facebook friends. In the example shown in FIG. 8(g), the user's list consists of the single entry “Debby Doe”. The list entry for each friend may contain other information about that friend, e.g., a photograph 815 of that friend. Preferably the list entry for each friend contains that friend's SNS profile photograph. So, in the example shown in FIG. 8(g), the profile entry for the friend “Debby Doe” contains the Facebook profile picture 815 for the friend Debby Doe. This picture is typically set by Debby Doe as her profile picture in Facebook, and is obtained from Facebook by the gifting system for display on the GUI. Other examples of lists of friends are shown in the GUIs of FIGS. 9(e) and 10(d)-10(e).

If a particular user has been given any gifts by other users (or has obtained gifts for themselves, e.g., from a campaign), those gifts may be stored in a structure referred to as a wallet associated with that particular user. With reference to FIG. 6(e) and the flowcharts in FIGS. 7(a) and 7(d) when a user selects the “wallet” region 614 of the GUI 602, functionality associate with that region is performed (“Process Wallet” 710, FIG. 7(d)). The functionality associated with the wallet features may be implemented, at least in part, by the client-side wallet application(s) 552-d on the user's computing device (executing as one or more client-side processes 570, including, e.g., client-side wallet process(es) 570-d, on the user's computing device), alone or in combination/interaction with the backend wallet application(s) 554-d on one or more computer systems associated with the gifting system 102 (executing as one or more backend processes 572, including, e.g., backend wallet process(es) 572-d, on the on the one or more computer systems associated with the gifting system).

Thus, the user is provided with a list 628 of zero or more items in that user's wallet 630-1, 630-2 . . . 630-m (at 730, FIG. 7(d)). In some embodiments, the GUI 602 also provides the user with a wallet search region 632 which the user may use to search their wallet for specific gifts or for gifts matching certain criteria (at 728, FIG. 7(d)). For example, the wallet search mechanism may support searching for all gifts from certain kinds of vendors (e.g., for food or drink) or for all gifts about to expire or all gifts in a certain region. If the user uses a customized wallet search, then the user is presented only with gifts in their wallet satisfying that search. The system may support any kind of gift search through the GUI 602 and the wallet search region 632. If a wallet search region 632 is provided, default values will preferably be used to provide a list of all of gifts in the user's wallet. The user may then select an item from their wallet (at 732, FIG. 7(d)).

With reference to the exemplary GUI in FIG. 8(g), when a user selects the area/region 814 denoted “Wallet”, the system presents the user with a list of some or all of the gifts that particular user has received. FIG. 9(e) shows a GUI showing some entries in a user's wallet using the gifting system via a smartphone device. FIG. 10(c) shows a GUI showing entries in a user's wallet using a computer device such as a computer or iPad or the like.

With reference to the GUI in FIG. 6(b) and the flowcharts in FIGS. 7(a) and 7(e), when the user selects a campaign from the list of campaigns 615 (at 738 in FIG. 7(e)) the user may then acquire/purchase the selected campaign (at 740 in FIG. 7(e)). The system may also provide the user with a mechanism for searching/pruning the list of campaigns (at 734). As noted, functionality associated with the campaigns may be implemented, at least in part, using the client-side campaign application(s) 552-j on the user's computing device (executing as one or more client-side processes 570, including, e.g., client-side campaign process(es) 570-j, on the user's computing device), alone or in interaction/combination with the backend campaign application(s) 554-j on one or more computer systems associated with the gifting system 102 (executing as one or more backend processes 572, including, e.g., backend campaign process(es) 572-j, on the on the one or more computer systems associated with the gifting system).

Gifting

In order to give a gift to a friend (or more than one friend), the user first selects a friend (or friends) using the friends region 612 of the GUI 602. As described above with reference to FIGS. 6(a) and 6(d), using the GUI the user is provided with a list 622 of friends 624-1, 624-2 . . . 624-m (collectively, friends 624). Using the GUI, the user may select one or more of those friends for gifting. The selection mechanism will depend on the GUI and the interface, and may include use of checkboxes and the like. In a presently preferred implementation, the user may select a friend by selecting (or clicking on) that friend in the list 622.

With respect to FIG. 6(f) having selected a friend (or friends) for gifting, the user is provided with a GUI 602 including a gift list 634, listing one or more gifts 636-1, 636-2 . . . 636-n from which the user can select. In some embodiments the user may invoke a gift search using a gift search region 638 of the GUI 602. The gift search, when provided, may support searching for gifts matching certain criteria (e.g., by one or more of vendor type, gift type, location, geographical region, etc.). If no search is done or if no search criteria are used then the gift list 634 lists all available gifts. Thus, e.g., a user may search for all gifts in a particular country. Or a user may search for all food-related gifts in a particular town. It should be appreciated that the system is not limited by the kinds of searching that may be done for gifts, and those of skill in the art will realize and understand, upon reading this description, that different and/or other gift search criteria may be used.

The ordering of the gifts on the gift list 634 and the selection of gifts for the gift list may use a selection process that takes various criteria into account, including information about the recipient(s) and the gift giver.

Preferably when a user is presented with a list of gifts to give away to another user, the list is filtered so that only gifts whose targeting matches the intended recipient are included. The selection, order and values of gifts may also be adjusted by an optimization engine 210 using various signals, e.g., demographics, previous usage patterns and predicted transaction sizes, to make sure that the offers that are most interesting to the recipient are included and promoted. Preferably the gifts available to a user depend on both the sender and recipient. In some embodiments, merchants may target specific user groups based on data from the users' SNS profiles (including but not limited to age, gender, location, interests, “likes”, interactions with other users and brands) and previous and expected behavior using the gifting system 102.

It should be appreciated that the gift list for a particular friend may be empty, e.g., if the friend is in a country or region in which no gifts are available. In such cases the system should notify the user that no gifts are available for that friend.

With reference to the flowchart in FIG. 7(f), to process a gift for one or more selected friends (at 720), the user is presented with a list of gifts 634 (at 744). The user may (optionally) search/prune the gift list (at 742). The user selects a gift from the list (at 746). The user may customize the gift and/or adjust its value (at 748). The user may select gift options (at 750). For example, the user may select/provide a gift message (at 752) and may select/provide gift delivery options (at 754). The user may purchase the gift (at 756). It should be appreciated that some of the actions are optional and may not be performed by the user or even provided by a particular system or by a particular merchant or for certain kinds of gifts. For example, not every gift may be customizable. In some cases a merchant may require a certain type of delivery and may not allow options.

Functionality associated with the gift features may be implemented, at least in part, using client-side applications including, e.g., the client-side gift application(s) 552-f and client-side delivery application(s) 552-h, and client-side purchase application(s) 552-e on the user's computing device (executing as one or more client-side processes 570, including, e.g., client-side gift process(es) 570-f, client-side delivery process(es) 570-h, and client-side purchase process(es) 570-e, on the user's computing device), alone or in interaction/combination with backend applications including, e.g., the backend gift application(s) 554-f, backend delivery application(s) 554-h, and delivery application(s) 552-h on one or more computer systems associated with the gifting system 102 (executing as one or more backend processes 572, including, e.g., backend gift process(es) 5724, backend delivery process(es) 572-h, and backend purchase process(es) 572-e, on the on the one or more computer systems associated with the gifting system).

With reference again to the actual embodiment of FIG. 8(g) which shows a particular GUI 816 having been presented with a list of friends, the user may then select one or more of those friends for gifting. In order to select a friend, the user selects (e.g., clicks) on the region of the display having the friend's name. The actual region corresponding to the friend is preferably a rectangular region around the friend's name. Those of skill in the art will realize and understand, upon reading this description, that the size of the region and the manner in which it is selected will depend on the kind of device used.

Thus, e.g., as shown in FIG. 8(h), having selected a friend from the list of friends, the user is presented with a page showing the friend's name and/or other identifying information (e.g., a photograph) and a list of gifts that can be given to that friend through the gifting system 102. In a presently preferred implementation the photograph, if provided, is obtained from the friend's SNS profile. In the example, as shown in FIG. 8(h), the user selects the friend “Debby Doe” and is provided with a screen interface 818 that allows the user to give a gift to the selected friend “Debby Doe” via the Facebook SNS. The gifting system 102 may try to determine the geographic location of the selected friend, e.g., using information obtained from the SNS. The gifting system 102 may also use other information, e.g., the web site through which the system is being accessed, to try to determine the selected friend's location. In the example shown in FIG. 8(h), the gifting system 102 initially assumes that the selected friend (Debby Doe) is located in Sweden and presents gifts appropriate for that location. The system may also allow the user to select other countries or local regions (e.g., states, towns, etc.) from which to select gifts for the selected friend. In this manner, as will be appreciated, a user may receive gifts that are more appropriate for that user and are more likely to be used. For example, a user living in the U.K. may not be able to use a coupon for a pizza in Sweden.

In the example shown in FIG. 8(h), the system displays a selection of gifts 836-1, 836-2 under the assumption that Debby Doe is located in Sweden. The user may select a region 838 of the display screen (denoted “SE” with an iconic representation of a Swedish flag) to change the region (this corresponds to the gift search region 638 of FIG. 6(f)). FIG. 8(i) shows a display 820 in which the user is given the option to change the location (from Sweden to the United Kingdom or Norway), i.e., to search for gifts from a different location. As shown in FIG. 8(j), the list of gifts that may be given to the selected user (Debby Doe) for the selected region (in this case the U.K.) is provided. The list of gifts may be provided in the form of images that look like gift coupons (e.g., such as coupon 836-3 shown in FIG. 8(k)), with the amount of the gift and the name of the merchant shown in the coupon. The coupon may also provide other information, e.g., limits on the coupon's validity. The gift giver (user) may scroll down the page to see more gift offers for the selected user. FIG. 8(l) shows portions of the page 626 presented to the gifting user with a list of eight possible gifts that may be given to the friend “Debby”. Other examples are shown in FIG. 10(g).

The manner of presenting the gifts to the gifting user should preferably be such as to allow the user to navigate through the list and select a gift from those presented.

While the system may show the user all possible gifts for the selected friend, in some implementations the gift giver may use a search mechanism 638 to search or prune the list of gifts. For example, the gift giver may only want to give gifts from certain types of merchants (e.g., restaurants and the like) or gifts that can be redeemed online, etc.

The list of gifts presented to the user and the order in which the gifts are presented may be based on one or more factors determined by the user and/or the gifting system. The selection of which gifts to present to the gift giver, and the order of those gifts, may be determined, at least in part by the optimization engine/application 202 (FIG. 2), and is discussed in greater detail below.

Gifts may be any type of value that can be transferred from one user to another or from a merchant to a user, or anything of value that a recipient can use, preferably in connection with a merchant. Gifts can be in the form of gift cards that can be used for a limited or unlimited range of a merchant's goods or for specific items. The gifts can also be donations to a third party, typically a charity.

When the gifting user selects a gift (by selecting one of the gifts presented on the display), the user is provided with a graphical user interface 602, e.g., as shown in FIG. 6(g), which allows the gift giver to customize the gift via a gift customization/adjustment region 640, and to set certain gift options via one or more gift options regions 642. In some embodiments the gift giver may provide a message with the gift via a gift message region 644. In some embodiments, the gift giver may set one or more gift delivery options using a gift delivery options region 646. The gift delivery options may include that manner in which the recipient is notified of the gift. The gift customization/adjustment region 640 may allow the user to adjust (increase or decrease) the value of the gift.

Functionality associated with the gift features shown in FIG. 6(g) may be implemented, at least in part, using client-side applications including, e.g., the client-side gift application(s) 552-f and client-side delivery application(s) 552-h, and client-side purchase application(s) 552-e on the user's computing device (executing as one or more client-side processes 570, including, e.g., client-side gift process(es) 570-f, client-side delivery process(es) 570-h, and client-side purchase process(es) 570-e, on the user's computing device), alone or in interaction/combination with backend applications including, e.g., the backend gift application(s) 554-f, backend delivery application(s) 554-h, and delivery application(s) 552-h on one or more computer systems associated with the gifting system 102 (executing as one or more backend processes 572, including, e.g., backend gift process(es) 5724, backend delivery process(es) 572-h, and backend purchase process(es) 572-e, on the on the one or more computer systems associated with the gifting system).

It should be appreciated that not every implementation of the gifting system need provide all of the options or customizations, and that some systems may require the gift giver to accept certain values for the gifts and may require certain delivery options. In addition, even if a gifting system does support options and customizations, merchants may be able to opt out of certain options and adjustments for some or all of their gifts. E.g., a particular merchant may always require that their gifts be posted on the recipient's Facebook wall, or that the gift value not be adjustable.

As shown in the exemplary GUI in FIG. 8(n), interface 828 may include a first region 744 that allows the gift giver to write a note to the recipient (this first region corresponds to gift message region 644 in FIG. 6(g)) In the interface 828 shown in FIG. 8(n), this first region 844 initially says “Write something nice to Debby”, and that text can be replaced by a personalized message from the gift giver to the recipient (in this example, Debby). In some implementation the user may be able to provide an audio and/or video message to the recipient. Such a message may be captured by the sender's device or may be pre-recorded. The giver may also be able, in some cases, to provide a link to a message in the message region.

The interface 828 may also include a second region 846 which, when selected, causes information about the gift to be sent to the recipient (this second region corresponds to the gift delivery options(s) region 646 in FIG. 6(g)). In the example interface 828 shown in FIG. 8(n), this second region is titled “Deliver your gift” and allows the gifting user to have the gift posted to the recipient's Facebook wall. Information about the gift may also (or instead) be sent to the recipient (or someone else) by use of email.

The graphical user interface 628 also allows the gifting user to change the amount of money to be gifted (or used on the gift). As shown in the GUI 828 of FIG. 8(n), the coupon 840 is initially for the sum of £5. A plus sign (“+”) in the top right of the gift coupon allows the gifting user to increase the gift amount. For example, as shown in FIG. 8(o), the gift amount has been increased to £30, and the gifting user is given the option of decreasing the gift amount (using the minus sign “−” on the left side of the coupon) or increasing the gift amount (using the plus sign on the right side of the coupon). The coupon 740 is a representation of the gift customization/adjustment region 640 in FIG. 6(g)).

Once the gift giver has selected the various options and customizations of their choice (e.g., when the gifting user is satisfied with the amount to be given and the delivery method), they may purchase the gift using the gift purchase region 648. Selecting the gift purchase region 648 directs the gift giver to a GUI 602 with a list 650 (FIG. 6(h)) of one or more payments service providers 652-1, 652-2 . . . 652-n. The PSPs may include credit card companies, online payment system, etc. The PSP may also allow the user to purchase a gift using points from a loyalty program (e.g., using frequent flyer miles).

The gift giver selects one of the PSPs from the list 650 and pays for the gift using that PSP.

Functionality associated with the gift purchase features described in FIGS. 6(g)-6(h) may be implemented, at least in part, using client-side applications, including, e.g., the client-side gift application(s) 552-f and the client-side purchase application(s) 552-e on the user's computing device (executing as one or more client-side processes 570, including, e.g., client-side gift process(es) 570-f and client-side purchase process(es) 570-e on the user's computing device), alone or in interaction/combination with backend applications, including, e.g., the backend gift application(s) 554-f and/or the backend purchase application(s) 554-e on one or more computer systems associated with the gifting system 102 (executing as one or more backend processes 572, including, e.g., backend gift process(es) 572-f and backend purchase process(es) 572-e, on the on the one or more computer systems associated with the gifting system).

For example, using the exemplary graphical user interface 728 shown in FIG. 8(o), the gifting user may select to purchase this gift for the selected friend by selecting the region 848 denoted “Buy this gift for Debby”. The region 848 in FIG. 8(o) corresponds the purchase gift region 648 in FIG. 6(g).

If the gifting user has not entered a message for the recipient in the first region, the system may prompt the user to provide such a message or remind the user that no such message has been provided. The gifting user is then directed to a payment interface 830 (shown in FIG. 8(p)) that allows the gifting user to pay for the gift. The payment interface 830 may list one or more payment service providers. In the example shown in the drawing, the payment interface 830 lists four payment service providers, namely MasterCard, Visa, Amex, and PayPal. The purchasing user selects a payment method and enters their required information for that method. The payment service provider advises the gifting system about the success or failure of the payment. If the user's payment is successful then the gift is delivered to the recipient in the manner selected by the gift giver.

The manner of purchasing a campaign is similar to that for purchasing a gift for a friend, except that since the user is buying the campaign for themselves, the user does not have to select a friend or a delivery method. Once purchased, a campaign appears in the user's wallet. In some preferred embodiments, when a user visits a web page associated with a campaign and logs in, e.g., by selecting that particular campaign from a campaign list, that user is immediately given a gift from the merchant. The gift may be delivered to the user by a default mechanism selected by the merchant.

In some embodiments the user chooses how to the deliver the gift: through one or more connected social-networking service, as an email, as a text message (SMS) or through some other channel.

In some embodiments the system will deliver the gift either immediately or at a later date set by the user explicitly or implicitly by choosing to celebrate a specific event. In addition to the delivery methods chosen, the system may send push messages to recipients who are already registered users, e.g., though an available smartphone push message infrastructure.

Once a gift has been purchased for a particular friend, other users may add to that gift. An indication that a gift has been purchased may be made by posting information about the gift on the friend's SNS site, e.g., on the friend's Facebook wall. As shown in FIG. 8(q), a gift has been given to the friend “Martha” and this is also presented on the gifting systems web page for the current user.

If the user selects a friend who has been given a gift (e.g., “Martha” in FIG. 8(q)), then the user is presented with a GUI that allows the user to contribute to that gift (see FIG. 8(r)). The process of contributing a gift is similar to that of purchasing a gift described with reference to FIG. 7(f), in that the user can select a gift message (752), adjust the gift's value (748) and then purchase the gift (756). Instead of contributing to an existing gift, the user may also give the recipient a new gift. The recipient friend is notified of the gift via email, or via their social networking service (e.g., Facebook) or text message. Existing users are notified of each gift card they receive, as well as any contributions.

Users (friends) who have been given gifts by other friends will appear in the user's app (or on their web GUI). The user will also see them on their SNS, if gift-card senders allow news about their gifts to be posted there.

Group Giving

When a gift is given to a recipient, that gift (or information about that gift) may be posted on the recipients SNS page (e.g., on their Facebook wall). Other users of the gifting system may contribute to an ongoing gift to increase its value. To do so they select an icon or region representing the gift from the recipient's SNS page and are directed to the gifting system (e.g., to the GUI 602 of FIG. 6(g)) where they can add to the gift, send a message and purchase additional value for the gift.

FIGS. 9(a)-9(j) show aspects of an example in which a gift is given to a recipient by one user and then another user increases the value of that gift. As shown in FIG. 9(a), the user is informed (via the events list) that his friend “Jeremie” is being celebrated. The GUI shown in FIG. 9(a) provides the user with a region which may be used to contribute to Jeremie's gift. As shown in FIG. 9(b), the user can view the current status of Jeremie's gift (shown in FIG. 9(b) as a gift of 50 kr for Hotel J from another user “Rage”). The user can give Jeremie a new gift or contribute to Jeremie's gift. If the user selects to contribute to Jeremie's gift, the user is given a GUI (FIG. 9(c)) that allows the user to increase Jeremie's gift.

There is preferably no limit to the number of friends who can add value to a gift card. Each merchant may decide on the maximum value of its gift card, however. In some cases, a user may not be able to contribute to a card because it has reached its maximum value.

In some embodiments, the gift giver can send an email or other message to a group of users informing them of the gift and providing them with a link to allow them to contribute to the gift.

A user is informed that someone gave them a gift via one of the provided delivery methods. If the user is not already a registered user of the gifting system 102, they are presented with the opportunity to join the system. In some cases the recipient may be offered the opportunity to download a smartphone app or to use the web-based client application. When they then connect to a SNS, the gifting system knows which gifts are given to them (because the SNS connection identifies the user) and can present those to the user.

For recipients who are already users of the gifting system 102, the gift is immediately available in their app or in the web-based client.

When a recipient has received their gift, they are presented with the opportunity to thank the givers, and to share the thank-you note in the same channels that a gift can be shared.

In some cases a user may redeem a gift in a brick-and-mortar store using a smartphone. In order to redeem their gift card, the user walks to a store, picks up the desired merchandise and proceeds to the cash register. The user then opens the gift app on their smartphone, selects the gift card they want to use, presses the “redeem” button and shows the presented gift card code and/or barcode to the cashier. The cashier enters or scans the code into the POS system, which deducts the gift card value from the transaction size. If there is still money left on the gift card, and the merchant supports it, the gift card remains in the user's wallet, otherwise it is considered consumed and is discarded. It should be appreciated that different and/or other redemption techniques may be used, and that any particular system and/or merchant may support multiple techniques of obtaining a code associated with a gift and getting that code into a POS terminal (or such device). For example, a system may support Near Field Communication (NFC) technology and/or a chip-and-PIN terminal.

If the user does not have a smartphone, or for some other reason does not want to use their smartphone for redemption, they can use the web-based application to print the gift card. They then take the print-out and walk to the store and proceed exactly like when redeeming a gift in a brick-and-mortar store using a smartphone.

In order to redeem a gift in an online store, the user finds the gift card in their wallet, presses a “redeem online” button and follows the on-screen link to the store and redemption instructions. Depending on the level of integration with the store, the user is either presented with a gift card code, or with a link that takes them directly to the store with the gift card already in their shopping cart. Either way, the gift card amount is deducted from the transaction size.

Sponsored (free) gift cards typically expire within a short time (say 30 or 60 days). When a sponsored gift card is converted to a paid-for gift card (or, rather, a hybrid gift card), the lifetime is extended, typically to 1-5 years or even forever. When a user's sponsored gift card is about to expire, they are given the option to contribute to it themselves in order to extend the lifetime.

### Data Collection

The gifting system may collect and store data about users' interactions and may use the stored data, directly or indirectly, to provide customized user experiences. In addition, stored data (or data derived therefrom) may be used to provide reports to merchants or other entities regarding user interactions with the gifting system.

Functionality associated with data collection may be implemented, at least in part, using one or more backend applications including, e.g., the backend data collection application(s) 554-k on one or more computer systems associated with the gifting system 102 (executing as one or more backend processes 572, including, e.g., backend data collection process(es) 572-k, on the on the one or more computer systems associated with the gifting system).

### The Optimization Engine

The gifting system 102 presents a set of gift cards and campaigns to an end user that he or she can give to a given friend. In preferred embodiments, each gift card comes from a campaign set up by a merchant (e.g., a retail partner) and the availability of gifts depends on the targeting defined for that campaign and the demographics of the recipient.

The order in which gift cards are displayed to a user for selection matters, since the first one is much more likely to be selected than the second one, which is in turn more likely to be selected than the third one and so on. The gifting system 102 therefore (using the optimization engine 210) preferably optimizes the order in which gift cards are listed (ranked) depending on various parameters, including one or more of: popularity of the retailer (number of times gift cards from that retailer have been given away, actively received, redeemed—either totals or fractions of the total number of gift cards sent or that could have been sent), a value of the campaign (face value of the gift card, how much the gifting system 102 will be paid or total value of the campaign), a value of the brand (which can be hand-tuned), return on investment at redemption for the retailer (i.e., total transaction size over value of sponsored gift card), likelihood of up-sell (by the giver or other friends) etc.

A rules-based system and a statistics-based machine-learning system may be used in conjunction to achieve this. The rules-based system may contain a set of programmatically encoded rules that assign a weight to aspects of a campaign, such as brand value (which can be hand-tuned) and orders the campaigns for a given recipient accordingly.

The statistics-based system infers likelihood of user behavior from previous behavior, both for that user, that user's friends and the entire population. The statistics-based system may look, for example, at the user's historical gift card redemptions and the total transaction value of each redemption, to determine the expected return on investment for a retail partner if that user receives a gift card. This information is input to the ranking, so that the system can optimize for various parameters.

Functionality associated with the optimizer may be implemented, at least in part, using the backend optimizer application(s) 554-1 on one or more computer systems associated with the gifting system 102.

Featured Listing

In order to provide maximum exposure, the top spots in the gift card listing can be allocated to one or more chosen retailers. This is referred to as a featured listing. Retailers in this section are displayed differently visually and always on the top of the list.

Promotional Campaigns

A promotional campaign is a web link devised specifically for a retailer. The link can be distributed in an e-mail newsletter to loyalty club members, on the retailer's Facebook page, on flyers in a shopping mall or by whichever method the retailer wants. The web link points to a specific page on the gifting system's website. When a person visits this page, they are given the opportunity to get a free gift card from the retailer. In order to receive the gift card, they sign up for the gifting system 102 service.

Becoming a Featured Retailer Through Promotional Campaigns

When a user signs up for the gifting system 102 using a promotional link from a specific retailer, the gifting system 102 system stores the fact that the user was created by that retailer, since it is very likely that the user is fond of that brand. Whenever that user then wants to give away a gift card to one of their friends, any available gift card from that retailer gets a featured position in the presented gift card listing. This can entail both the first spot and specific graphical highlighting.

Other ways of becoming a featured retailer: Being the featured retailer for a specific target audience can also be packaged as an ad product that's marketed to retailers.

As used herein, the term “merchant” may refer to any entity to which currency can be given, including a retailer. Currency can be real or virtual currency and may include anything that a party considers to have value and/or for which something may be traded.

Thus are described methods, systems and devices supporting gifting applications, platforms, systems, frameworks and services.

In presently preferred exemplary implementations of a gifting system, users register an account and access a platform using a mobile handset, computer or other hardware or device. In presently preferred exemplary implementations of a gifting system, in order to be able to use services, users are required to register an account and allow the system to connect a social network account (e.g., Facebook) to the platform. Implementations of the gifting system may rely on the relevant social network to authorize users of services.

User's may be required to authorize (expressly or otherwise) the gifting system to receive certain of their information that is available on or through their social network account(s), including, without limitation, their profile information, friends or follower names, their photos, privacy settings. Users may also be required to authorize the gifting system to generate and publish on their social network news feed and timeline (as applicable) actions they take on the platform or while using the services, and to allow users to interact with their social network friends on the platform or while using the services. Users may be required to allow social networks to receive information concerning the actions they take on the platform or their use of services.

In some aspects, an exemplary implementation of the system may offer users the opportunity to give and receive gifts in the form of electronic gift cards provided by various third-party businesses (e.g., merchants) to be used for the purchase of products and services at the stores of the merchants (or at the stores of others). The merchants who participate in offering services may choose to offer certain target groups gift cards (e.g., via sponsored gift cards) free of charge to give away to certain social network friends. To be able to receive a sponsored gift card, the user's friend may also have registered an account with the system. The friends available through their social network profile who are eligible to receive sponsored gift cards may be determined by target groups which the merchants have selected. Therefore, it should be appreciated that some gift cards may be available to give away only to certain of a particular user's friends and not to other of that particular user's friends because they belong to different target groups.

In another aspect of exemplary implementations of a gifting system, users of the system may choose to purchase gift cards (i.e., paid gift cards) that are not offered free of charge. Paid gift cards may be offered by the gifting system in several predetermined values. To give a paid gift card to a friend, a user selects the merchant from which that user would like to purchase the paid gift card and then chooses the value of the paid gift card. To purchase a paid gift card the user chooses the payment type (e.g., PayPal, debit or credit cards, or the like), provides the appropriate information and completes their purchase. Thereafter the user may receive a confirmation of the purchase and the amount charged. Paid gift cards are preferably not available for use until full payment has been made.

In yet some other aspects of exemplary implementations of the system, users may also able to add value to an existing sponsored gift card (which then becomes a “hybrid gift card”) or an existing paid gift card. In some implementations this may only be possible by making an additional payment in relation to that gift card.

In yet some other aspects of exemplary implementations of the system, in order to redeem a gift card that a user has received and to use the credit to purchase a product or service from a merchant, the user may either go to the merchant's physical business and display the gift card on their device to the merchant's representative or provide gift card information at the merchant's website. (Some gift cards may be used in both ways; others may be limited to one or the other.) In some embodiments, for all sponsored gift cards and selected paid gift cards the user may redeem the full value of the gift card in one visit. In some systems, no cash-backs or other credit will be accepted by merchants (unless they are required to do so under applicable laws). In some systems, once a user activates a gift card they may have a limited time period to access the gift card code and redeem the gift card. After that time period expires, the gift card may not be used.

In some other aspects of exemplary implementations of a gifting system, services can be accessed from several countries. Some products or services may be provided by merchants only in certain geographical areas and jurisdictions. A gifting system may therefore exclude the provision of certain gift cards to certain geographical areas and jurisdictions.

In yet some other aspects of exemplary implementations of a gifting system, gift cards may be issued with specific terms, such as the period during which the gift card is valid and the date it expires.

In some other aspects of exemplary implementations of a gifting system, the system may offer special promotions, contests and/or sweepstakes intended to provide incentives to purchase gift cards. The applicable rules for such special promotional activities may be posted, e.g., on the system's website in connection with the description of each promotion.

Computing

As noted above, although shown in FIGS. 5(b)-5(c) as separate applications in the drawing, this separation is for descriptive purposes only, and it should be appreciated that the particular functionality associated with any particular application may be shared with or integrated into other applications. In addition, it should be understood that the various applications shown may interface and interact with each other as needed. For example, various backend applications may need to obtain information from a SNS, in which case they may interface with and interact with the SNS via the backend SNS interface application(s) 554-i. Similarly, many of the backend applications may need to store, obtain or maintain information from one or more of the databases 212 (FIG. 2). Accordingly, these applications may interface/interact with the backend database application(s) 554-b.

In should be appreciated that the various applications may interact with each other directly or indirectly. It should also be appreciated that the various applications may interact with other applications, including external applications, as needed.

Programs that implement such methods (as well as other types of data) may be stored and transmitted using a variety of media (e.g., computer readable media) in a number of manners. Hard-wired circuitry or custom hardware may be used in place of, or in combination with, some or all of the software instructions that can implement the processes of various embodiments. Thus, various combinations of hardware and software may be used instead of software only.

It should be noted that, in addition to the process(es) 550-2 that carry/carries out operations as discussed herein, other embodiments herein include the application(s) 550-1 itself/themselves (i.e., the un-executed or non-performing logic instructions and/or data). Some or all of the application(s) 550-1 may be stored on a computer readable medium (e.g., a repository) such as a disk, hard disk or in an optical medium. According to other embodiments, some or all of the application(s) 550-1 can also be stored in a memory type system such as in firmware, read only memory (ROM), or, as in this example, as executable code within the main memory 504 (e.g., within Random Access Memory or RAM). For example, some or all of the application(s) 550-1 may also be stored in removable storage media 505, read-only memory 506, and/or mass storage device 507.

With reference again to FIG. 5(a), processor(s) 502 can be any known processor, such as, but not limited to, an Intel® Itanium® or Itanium 2® processor(s), AMD® Opteron® or Athlon MP® processor(s), or Motorola® lines of processors, and the like. Communications port(s) 903 can be any of an RS-232 port for use with a modem based dial-up connection, a 10/100 Ethernet port, a Gigabit port using copper or fiber, or a USB port, and the like. Communications port(s) 503 may be chosen depending on a network such as a Local Area Network (LAN), a Wide Area Network (WAN), a CDN, or any network to which the computer system 500 connects.

Main memory 504 can be Random Access Memory (RAM), or any other dynamic storage device(s) commonly known in the art. Read-only memory 506 can be any static storage device(s) such as Programmable Read-Only Memory (PROM) chips for storing static information such as instructions for processor(s) 502. Mass storage 507 can be used to store information and instructions. For example, hard disks such as the Adaptec® family of Small Computer Serial Interface (SCSI) drives, an optical disc, an array of disks such as Redundant Array of Independent Disks (RAID), such as the Adaptec® family of RAID drives, or any other mass storage devices may be used.

Bus 501 communicatively couples processor(s) 502 with the other memory, storage and communications blocks. Bus 501 can be a PCI/PCI-X, SCSI, a Universal Serial Bus (USB) based system bus (or other) depending on the storage devices used, and the like. Removable storage media 505 can be any kind of external hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM), etc.

Embodiments herein may be provided as a computer program product, which may include a machine-readable medium having stored thereon instructions, which may be used to program a computer (or other electronic devices) to perform a process. As used herein, the term “machine-readable medium” refers to any medium, a plurality of the same, or a combination of different media, which participate in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory, which typically constitutes the main memory of the computer. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications.

The machine-readable medium may include, but is not limited to, floppy diskettes, optical discs, CD-ROMs, magneto-optical disks, ROMs, RAMs, erasable programmable read-only memories (EPROMs), electrically erasable programmable read-only memories (EEPROMs), magnetic or optical cards, flash memory, or other type of media/machine-readable medium suitable for storing electronic instructions. Moreover, embodiments herein may also be downloaded as a computer program product, wherein the program may be transferred from a remote computer to a requesting computer by way of data signals embodied in a carrier wave or other propagation medium via a communication link (e.g., modem or network connection).

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols; and/or (iv) encrypted in any of a variety of ways well known in the art.

A computer-readable medium can store (in any appropriate format) those program elements which are appropriate to perform the methods.

Example functionality supported by computer system 500 and, more particularly, functionality associated with application(s) 550-1 is discussed above with reference to FIGS. 5(e)-5(f), 6(a)-6(h), 7(a)-7(f), and 8(a)-8(o).

Those skilled in the art will understand that the computer system 500 can include other processes and/or software and hardware components, such as an operating system that controls allocation and use of hardware resources.

As discussed herein, embodiments of the present invention include various steps or operations. A variety of these steps may be performed by hardware components or may be embodied in machine-executable instructions, which may be used to cause a general-purpose or special-purpose processor programmed with the instructions to perform the operations. Alternatively, the steps may be performed by a combination of hardware, software, and/or firmware. The term “module” refers to a self-contained functional component, which can include hardware, software, firmware or any combination thereof.

One of ordinary skill in the art will readily appreciate and understand, upon reading this description, that embodiments of an apparatus may include a computer/computing device operable to perform some (but not necessarily all) of the described process.

Embodiments of a computer-readable medium storing a program or data structure include a computer-readable medium storing a program that, when executed, can cause a processor to perform some (but not necessarily all) of the described process.

Where a process is described herein, those of skill in the art will appreciate that the process may operate without any user intervention. In another embodiment, the process includes some human intervention (e.g., a step is performed by or with the assistance of a human).

It should be appreciated that the words “first”, “second”, “third,” and so on in the claims are used to distinguish or identify, and not to show a serial or numerical limitation. Similarly, the use of letter or numerical labels (such as “(a)”, “(b)”, and the like) are used to help distinguish and/or identify, and not to show any serial or numerical limitation or ordering.

Thus is described a gift-giving infrastructure/system, including associated processes, devices and articles of manufacture. The system supports a social gift-giving service that lets users give free and paid gifts (e.g., gift cards) to friends and family using their computers or smartphones.

While the invention has been described in connection with what is presently considered to be the most practical and preferred embodiments, it is to be understood that the invention is not to be limited to the disclosed embodiment, but on the contrary, is intended to cover various modifications and equivalent arrangements included within the spirit and scope of the appended claims.

1-19. (canceled)

20. A computer-implemented method, implemented by hardware in combination with software, the method operable with a social networking service, the method comprising:
(A) providing a graphical user interface (GUI) to a social networking service (SNS) on a display of a computing device, said GUI comprising a first region having first functionality associated therewith;
(B) in response to selection of said first region, displaying on said GUI information of one or more other users of said social networking service, said one or more other users being associated with a first user;
(C) responsive to selection, using said GUI, of a particular user of said one or more other users displayed in (B), displaying on said GUI information about one or more gifts of a plurality of gifts, said information about said one or more gifts having been specifically filtered and ordered for said at particular user,
wherein selection of said one or more gifts of said plurality of gifts to be displayed in (C) is based on both (i) the sender and (ii) the particular user, and wherein selection of said one or more gifts of said plurality of gifts to be displayed is based on one or more of: (x) demographics associated with said particular user, (y) previous usage patterns associated with said particular user, and (z) predicted transaction sizes associated with said particular user;
(D) responsive to selection, using said GUI, of a particular gift of said one or more gifts, said GUI providing a gift purchase region supporting purchase of said particular gift for said particular user; and
(E) responsive to selection, using said GUI, of said gift purchase region, said GUI supporting using the GUI for a sender to obtain the particular gift for the particular user.

21. The method of claim 20 wherein at least some of said plurality of gifts comprise gifts associated with one or more campaigns set up by one or more merchants, each campaign having targeting associated therewith, and wherein said one or more gifts displayed in (C) was selected based on targeting associated with the one or more campaigns.

22. A computer-implemented method, implemented by hardware in combination with software, the method operable with a social networking service, the method comprising:
(A) providing a graphical user interface (GUI) to a social networking service (SNS) on a display of a computing device, said GUI comprising a first region having first functionality associated therewith;
(B) in response to selection of said first region, displaying on said GUI information of one or more other users of said social networking service, said one or more other users being associated with a first user;
(C) responsive to selection, using said GUI, of a particular user of said one or more other users displayed in (B), displaying on said GUI information about one or more gifts of a plurality of gifts, said information about said one or more gifts having been specifically filtered and ordered for said at particular user;
(D) responsive to selection, using said GUI, of a particular gift of said one or more gifts, said GUI providing a gift purchase region supporting purchase of said particular gift for said particular user; and
(E) responsive to selection, using said GUI, of said gift purchase region, said GUI supporting using the GUI for a sender to obtain the particular gift for the particular user.

23. The method of claim 22 wherein at least some of said plurality of gifts target certain users, and wherein said information about said one or more gifts was specifically filtered so that gifts targeting said particular user are displayed on said GUI in (C).

24. The method of claim 22 wherein selection of said one or more gifts of said plurality of gifts to be displayed in (C) is based on one or more of: (i) demographics associated with said particular user, (ii) previous usage patterns associated with said particular user, and (iii) predicted transaction sizes associated with said particular user.

25. The method of claim 22 wherein selection of said one or more gifts of said plurality of gifts to be displayed in (C) is based on both (i) the sender and (ii) the particular user.

26. The method of claim 22 wherein said one or more gifts of a plurality of gifts comprise a list of gifts, and wherein an order of said list is based on both the sender and the particular user.

27. The method of claim 22 wherein value of said one or more gifts of said plurality of gifts to be displayed in (C) is based on both the sender and the particular user.

28. The method of claim 22 wherein the at least some of plurality of gifts are targeted to specific groups of users based on data from said users' SNS profiles.

29. The method of claim 28 wherein said data from said users' SNS profiles comprises one or more of users′: age, gender, location, interests, SNS likes, and interactions with other users and brands.

30. The method of claim 28 wherein said method is implemented within a gifting system, and wherein the at least some of plurality of gifts are targeted to specific groups of users based on previous and expected behavior using the gifting system.

31. The method of claim 22 wherein at least some of said plurality of gifts comprise gifts associated with one or more campaigns set up by one or more merchants, each campaign having targeting associated therewith, and wherein said one or more gifts displayed in (C) was selected based on targeting associated with the one or more campaigns.

32. The method of claim 31 wherein said one or more gifts displayed in (C) was selected based on targeting associated with the campaign and demographics of the particular user.

33. The method of claim 22 wherein said GUI further comprises a delivery options region providing support for setting, using said GUI, options for delivery of said particular gift to said particular other user.

34. The method of claim 33 wherein a delivery date of said particular gift to said particular user is set explicitly using said delivery options region.

35. The method of claim 22 wherein a delivery date of said particular gift to said particular user is set implicitly by choosing to celebrate a specific event.

36. The method of claim 35 wherein said delivery date is set at a later date.

37. The method of claim 22 wherein said particular user is associated with a particular geographic location, and wherein said one or more gifts are selected for display based on said particular geographic location.

38. The method of claim 22 wherein said particular user is associated with a particular geographic location, and wherein said one or more gifts are selected for display based on another geographic location distinct from said particular geographic location, wherein said GUI supports selection of said other geographic location.

39. The method of claim 22 wherein the computing device is selected from the group comprising:
a desktop computer, a laptop computer, a tablet computing device, a mobile phone, a smartphone, and a set-top box.

40. Non-transitory computer-readable storage media containing instructions that when executed by one or more processors cause the one or more processors to perform a method comprising:
(A) providing a graphical user interface (GUI) to a social networking service (SNS) on a display of a computing device, said GUI comprising a first region having first functionality associated therewith;
(B) in response to selection of said first region, displaying on said GUI information of one or more other users of said social networking service, said one or more other users being associated with a first user;
(C) responsive to selection, using said GUI, of a particular user of said one or more other users displayed in (B), displaying on said GUI information about one or more gifts of a plurality of gifts, said information about said one or more gifts having been specifically filtered and ordered for said at particular user;
(D) responsive to selection, using said GUI, of a particular gift of said one or more gifts, said GUI providing a gift purchase region supporting purchase of said particular gift for said particular user; and
(E) responsive to selection, using said GUI, of said gift purchase region, said GUI supporting using the GUI for a sender to obtain the particular gift for the particular user.

41. A device comprising hardware, including at least one processor and software, in combination with said hardware:
(A) to provide a graphical user interface (GUI) to a social networking service (SNS) on a display of a computing device, said GUI comprising a first region having first functionality associated therewith;
(B) in response to selection of said first region, to display on said GUI information of one or more other users of said social networking service, said one or more other users being associated with a first user;
(C) responsive to selection, using said GUI, of a particular user of said one or more other users displayed in (B), to display on said GUI information about one or more gifts of a plurality of gifts, said information about said one or more gifts having been specifically filtered and ordered for said at particular user;
(D) responsive to selection, using said GUI, of a particular gift of said one or more gifts, said GUI to provide a gift purchase region supporting purchase of said particular gift for said particular user; and
(E) responsive to selection, using said GUI, of said gift purchase region, said GUI to support use of the GUI for a sender to obtain the particular gift for the particular user.
